(19) United States
(12) Patent Application Publication
(10) Pub. No.: US 2024/0256964 A1
(43) Pub. Date: Aug. 1, 2024

(54) Pretraining Already-Pretrained Models for Diverse Downstream Tasks

(71) Applicant: Google LLC, Mountain View, CA (US)

(72) Inventors: Yi Tay, Singapore (SG); Mostafa Dehghani, Amsterdam (NL)

(21) Appl. No.: 18/424,031

(22) Filed: Jan. 26, 2024

(30) Foreign Application Priority Data
Jan. 27, 2023 (SG) 10202300220Q

(51) Int. Cl. G06N 20/00; G06F 7/483

(52) U.S. Cl. CPC G06N 20/00; G06F 7/483

(57) ABSTRACT

An example method includes obtaining a pretrained machine-learned model that was initially pretrained using a pretraining dataset and further pretraining the model by generating, using a pretraining objective framework, a plurality of corrupted training examples from one or more training examples obtained from the pretraining dataset. A first set of one or more training examples can be corrupted according to a first set of configuration parameters of the pretraining objective framework. A second set can be corrupted according to a second set of configuration parameters of the pretraining objective framework. The example method includes inputting the plurality of corrupted training examples into model; obtaining from the model, a plurality of outputs respectively generated by model based on the plurality of corrupted training examples; and updating one or more parameters of model based on an evaluation of the plurality of outputs.

### PRIORITY

The present application claims priority to and the benefit of Singapore Patent Application No. 10202300220Q, filed Jan. 27, 2023. Singapore Patent Application No. 10202300220Q is hereby incorporated by reference herein in its entirety.

### FIELD

The present disclosure relates generally to pretraining machine-learned models. More particularly, the present disclosure relates to improved objectives for pretraining.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

The training of machine-learned models can be completed in stages. A model can be pre-trained for general release and subsequently fine-tuned for specific tasks. Pre-training can include pursuit of unsupervised objectives across unlabeled training datasets, often followed by supervised learning on smaller, labeled datasets in the fine-tuning stage.

### SUMMARY

Aspects and advantages of embodiments of the present disclosure will be set forth in part in the following description, or can be learned from the description, or can be learned through practice of the embodiments.

Example aspects of the present disclosure provide an example method of improving the performance of a pretrained a machine-learned model by further pretraining with diverse objectives. The example method can include obtaining, by a computing system including one or more processors, a pretrained machine-learned model that was initially pretrained using a pretraining dataset. The example method can include further pretraining the pretrained machine-learned model by generating, by the computing system and using a pretraining objective framework, a plurality of corrupted training examples from one or more training examples obtained from the pretraining dataset. In the example method, the plurality of corrupted training examples can include a first set of one or more training examples corrupted according to a first set of configuration parameters of the pretraining objective framework; and a second set of one or more training examples corrupted according to a second set of configuration parameters of the pretraining objective framework. The example method can include further pretraining the pretrained machine-learned model by inputting, by the computing system, the plurality of corrupted training examples into the pretrained machine-learned model, wherein the pretrained machine-learned model is configured to generate uncorrupted subportions corresponding to corrupted subportions of the plurality of corrupted training examples. The example method can include further pretraining the pretrained machine-learned model by obtaining, by the computing system and from the pretrained machine-learned model, a plurality of outputs respectively generated by the pretrained machine-learned model based on the plurality of corrupted training examples. The example method can include further pretraining the pretrained machine-learned model by updating, by the computing system, one or more parameters of the pretrained machine-learned model based on an evaluation of the plurality of outputs.

In some implementations of the example method, the one or more training examples were already used during the pretraining of the pretrained machine-learned model.

In some implementations of the example method, the pretrained machine-learned model was initially pretrained using a first number of floating point operations (FLOPs); and

In some implementations of the example method, the further pretraining is characterized by a second number of FLOPs that is less than or equal to one percent of the first number.

In some implementations of the example method, the pretrained machine-learned model was initially pretrained using a first number of floating point operations (FLOPs); and

In some implementations of the example method, the further pretraining is characterized by a second number of FLOPs that is less than or equal to one tenth of one percent of the first number.

In some implementations of the example method, the pretrained machine-learned model was initially pretrained using a first number of tokens from the pretraining dataset; and

In some implementations of the example method, the further pretraining is characterized by a second number of tokens that is less than or equal to one percent of the first number.

In some implementations of the example method, the pretrained machine-learned model was initially pretrained using a first number of tokens from the pretraining dataset; and

In some implementations of the example method, the further pretraining is characterized by a second number of tokens that is less than or equal to one tenth of one percent of the first number.

In some implementations of the example method, the initial pretraining was based on a causal language modeling objective.

In some implementations of the example method, the initial pretraining was based on one of more objectives consisting essentially of a causal language modeling objective.

In some implementations of the example method, the first set of one or more training examples are characterized by corrupted spans following an initial prefix at a start of an input sequence of a corresponding training example.

In some implementations of the example method, the second set of one or more training examples are characterized by at least one of: corrupted spans having a mean span length between 20 tokens and 40 tokens, or corrupted spans that are corrupted at a rate between 25 percent and 60 percent.

In some implementations of the example method, the second set of one or more training examples are characterized by at least one of: corrupted spans having a mean span length of 32 tokens, or corrupted spans that are corrupted at a rate of 50 percent.

In some implementations of the example method, the plurality of corrupted training examples include at least twice as many examples in the first set as in the second set.

In some implementations of the example method, the plurality of corrupted training examples include a third set of one or more training examples that are characterized by corrupted spans having a mean span length less than 10 tokens, wherein subportions of the corrupted spans are corrupted at a rate less than 20 percent.

In some implementations of the example method, the plurality of corrupted training examples include a third set of one or more training examples that are characterized by corrupted spans having a mean span length less than 10 tokens, wherein subportions of the corrupted spans are corrupted at a rate less than 20 percent. In some implementations of the example method, the plurality of corrupted training examples include: twice as many examples in the first set as in the second set; and an equal number examples in the third set as in the second set.

In some implementations, the example method includes training, during the further pre-training, the pretrained machine-learned model to receive a mode-switching token that triggers downstream behavior of the machine-learned model corresponding to a task associated with the mode-switching token.

In some implementations of the example method, the pretrained model was not trained, during the initial pretraining, to receive the mode-switching token that triggers downstream behavior of the machine-learned model corresponding to the task associated with the mode-switching token.

Example aspects of the present disclosure provide one or more example non-transitory, computer-readable media storing an example pretrained machine-learned model. The example pre-trained machine-learned model can have parameters that were obtained using at least two stages of pretraining. A first stage of pretraining can use a pretraining dataset. The second stage of the pretraining can include further pretraining the pretrained machine-learned model by generating using a pretraining objective framework, a plurality of corrupted training examples from one or more training examples obtained from the pretraining dataset. In further training the example pre-trained machine-learned model, the plurality of corrupted training examples can include a first set of one or more training examples corrupted according to a first set of configuration parameters of the pretraining objective framework; and a second set of one or more training examples corrupted according to a second set of configuration parameters of the pretraining objective framework. The second stage of the pretraining can include further pretraining the pretrained machine-learned model by inputting the plurality of corrupted training examples into the pretrained machine-learned model, wherein the pretrained machine-learned model is configured to generate uncorrupted subportions corresponding to corrupted subportions of the plurality of corrupted training examples. The second stage of the pretraining can include further pretraining the pretrained machine-learned model by obtaining, from the pretrained machine-learned model, a plurality of outputs respectively generated by the pretrained machine-learned model based on the plurality of corrupted training examples. The second stage of the pretraining can include further pretraining the pretrained machine-learned model by updating one or more parameters of the pretrained machine-learned model based on an evaluation of the plurality of outputs.

In some implementations of the one or more example non-transitory, computer-readable media, the example pretrained machine-learned model includes a decoder-only model. In some implementations of the one or more example non-transitory, computer-readable media, the example pretrained machine-learned model includes n encoder-decoder model. In some implementations of the one or more example non-transitory, computer-readable media, the one or more training examples were already used during the pretraining of the pretrained machine-learned model.

Example aspects of the present disclosure provide an example computing system. The example computing system can include one or more processors and one or more non-transitory, computer-readable media that store a pretrained machine-learned model having parameters that were obtained using at least two stages of pretraining. A first stage of pretraining can use a pretraining dataset. The second stage of the pretraining can include further pretraining the pretrained machine-learned model by generating using a pretraining objective framework, a plurality of corrupted training examples from one or more training examples obtained from the pretraining dataset. In further training the example pre-trained machine-learned model, the plurality of corrupted training examples can include a first set of one or more training examples corrupted according to a first set of configuration parameters of the pretraining objective framework; and a second set of one or more training examples corrupted according to a second set of configuration parameters of the pretraining objective framework. The second stage of the pretraining can include further pretraining the pretrained machine-learned model by inputting the plurality of corrupted training examples into the pretrained machine-learned model, wherein the pretrained machine-learned model is configured to generate uncorrupted subportions corresponding to corrupted subportions of the plurality of corrupted training examples. The second stage of the pretraining can include further pretraining the pretrained machine-learned model by obtaining, from the pretrained machine-learned model, a plurality of outputs respectively generated by the pretrained machine-learned model based on the plurality of corrupted training examples. The second stage of the pretraining can include further pretraining the pretrained machine-learned model by updating one or more parameters of the pretrained machine-learned model based on an evaluation of the plurality of outputs.

The non-transitory, computer-readable media of the example computing system can store instructions that are executable to cause the one or more processors to perform operations. The operations can include receiving one or more inputs for processing using the pretrained machine-learned model; and generating, by processing the one or more inputs using the pretrained machine-learned model, one or more outputs.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1A is a block diagram of a networked computing system that can implement aspects of an example pretraining framework according to example embodiments of the present disclosure, or host or execute models pretrained according to example embodiments of the present disclosure.

FIG. 1B is a block diagram of an example computing device that can implement aspects of an example pretraining framework according to example embodiments of the present disclosure, or host or execute models pretrained according to example embodiments of the present disclosure.

FIG. 1C is a block diagram of an example computing device that can implement aspects of an example pretraining framework according to example embodiments of the present disclosure, or host or execute models pretrained according to example embodiments of the present disclosure.

FIG. 2 is a block diagram of an example pretraining framework according to example embodiments of the present disclosure.

FIG. 3A is a block diagram of example training examples according to example embodiments of the present disclosure.

FIG. 3B is a block diagram of example corrupted training examples according to example embodiments of the present disclosure.

FIG. 4A is a block diagram of example corrupted training examples according to example embodiments of the present disclosure.

FIG. 4B is a block diagram of example corrupted training examples according to example embodiments of the present disclosure.

FIG. 5A is a chart illustrating example performance improvements obtained using pretraining according to example embodiments of the present disclosure.

FIG. 5B is a chart illustrating example performance improvements obtained using pretraining according to example embodiments of the present disclosure.

FIG. 6 is an illustration of different outputs demonstrating qualitative differences between models pretrained according to example embodiments of the present disclosure and models not pretrained according to example embodiments of the present disclosure.

FIG. 7 is a flow chart diagram of an example method to perform pretraining according to example embodiments of the present disclosure.

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure;

FIG. 14 is a block diagram of an inference system for operating one or more machine-learned model(s) to perform inference according to example implementations of aspects of the present disclosure;

### DETAILED DESCRIPTION

Generally, the present disclosure is directed to techniques for enhancing the performance of pretrained machine-learned models by further pretraining them with a diverse set of objectives. Traditional techniques often rely on a singular pretraining objective, such as causal language modeling, which may limit an ability of a model to generalize across different tasks or understand complex patterns within data. Example implementations of the present disclosure enrich the training of the model through exposure to a diverse array of pretraining objectives.

Traditional techniques often pretrain with a singular focus on a particular type of objective. This focus can lead to models that excel at specific tasks but lack the versatility to adapt to new or varied types of data. This can result in suboptimal performance when models encounter scenarios that diverge from their initial training conditions. Furthermore, the need to train large models from scratch for each new objective presents significant computational overhead, making such approaches resource-intensive and less efficient.

In contrast, example implementations of the present disclosure overcome these challenges using a diverse array of pretraining objectives. Advantageously, the benefits of this pretraining technique can be obtained without training each model anew: example implementations can further pretrain an already pretrained machine-learned model, significantly reducing the need for additional resources (additional compute, additional training data). For example, instead of starting from scratch, example implementations include further pretraining a model on the same pretraining dataset but with additional or different objectives (e.g., denoising objectives with varied configurations, such as different span lengths and corruption rates). Notably, the additional pretraining can provide substantial benefits even using only a small fraction of the computational cost-sometimes less than one percent—compared to the original pretraining.

In addition to improved flexibility and overall performance, example techniques according to the present disclosure can imbue pretrained models with emergent abilities that were previously only associated with much larger models. By integrating a mixture of prefix language modeling and diverse span corruption denoising tasks, example methods can allow the model to leverage bidirectional attention and infilling capabilities, leading to substantial improvements in downstream tasks-even without any “new” knowledge in the training data. The model can become more adept at handling a wider range of prompts and can develop new capabilities, such as mode-switching, which enables it to trigger specific downstream behaviors in response to certain tokens. This flexibility can allow an example model to adapt to various tasks without the need for further fine-tuning (e.g., on more expensive, labeled data), making it more versatile and practical for real-world applications. Additionally, or alternatively, such a robust pretraining technique can allow a more efficient fine-tuning stage (e.g., less labeled data, fewer iterations, etc.) to achieve satisfactory results.

More particularly, example implementations of the present disclosure can involve obtaining a previously pretrained machine-learned model. This model may have been trained on a pretraining dataset (e.g., using conventional objectives, such as causal language modeling). To improve performance of this model, example implementations can initialize a model for training with parameters obtained from its prior training and perform further pretraining using a diverse array of pretraining objectives.

For instance, example implementations of the present disclosure can include using a pretraining objective framework to generate a plurality of corrupted training examples from the pretraining dataset. This framework can be employed in various configurations to introduce noise into the training data, which the model can then learn to correct. Adding noise to, or corrupting, an existing portion of a training example can provide an opportunity to self-supervise the model's predictive ability. The model can be instructed to recover the corruption portions of the training example, and the model's performance can be judged by comparison to the known original portions. Advantageously, diverse configuration of how the training examples are noised or corrupted can induce different types of learning in the model.

In an example, a computing system can generate a first set of corrupted training examples using a first set of configuration parameters for the pretraining objective framework. In an example, the configuration parameters can define that a corrupted span of a training example (e.g., a span of tokens in a tokenized sequence of text) start following an initial prefix at the beginning of an input sequence. An example of this type of corruption includes the PrefixLM objective.

In an example, a computing system can generate a second set of corrupted training examples using a second set of configuration parameters for the pretraining objective framework. In an example, the configuration parameters can define more extreme forms of corruption of the training example. For instance, large contiguous spans of text may be replaced with a single placeholder token, or up to half of the text (or more) may be obscured. Training on these severely corrupted examples can challenge the model to infer and reconstruct information from very limited context, thereby improving its reasoning and infilling capabilities.

In an example, these corrupted training examples can be input to the pretrained machine-learned model. The model can predict values for the corrupted portions of the text. Outputs generated by the pretrained machine-learned model based on the corrupted training examples are then obtained.

Based on these outputs, a training computing system can update the parameters of the model. Evaluation of the parameters can be based on various metrics, such as the accuracy of the reconstructed text or the fluency and coherence of the generated content.

In further example implementations, this process of further pretraining can cause the model to learn to recognize and respond to mode-switching tokens. These tokens can act as signals that cause internal reasoning pathways within the model to switch between different modes of operation (e.g., performing a task-specific function). For example, a mode-switching token might prompt the model to shift from generating narrative prose to solving a mathematical equation embedded within a story.

In example implementations, techniques according to the present disclosure can be particularly data-efficient by reusing the existing pretraining dataset. This reuse of data can be enabled by the diverse pretraining objectives, which can create different learning experiences for the model, even when using the same underlying dataset. For example, presenting the same examples in a differently transformed or corrupted manner can expose the model to new challenges that cause it to learn different aspects of the information contained within the examples. This can lead to a more robust understanding of the language and concepts represented in the dataset.

For instance, a text passage used during initial pretraining in a left-to-right, causal learning approach could be reintroduced with certain words or phrases randomly masked in different configurations. The model, which may have already learned a baseline representation of the knowledge represented in the passage, can be challenged anew to recall that understanding based on different inputs. This process can encourage the model to develop a deeper comprehension of context and the relationships between different parts of the text.

This data-efficient approach can be particularly beneficial in contexts in which the collection of new training data is impractical or impossible. For example, in domain-specific applications where data is scarce or in languages with limited resources, the ability to repurpose existing datasets can be a substantial advantage in the continued development and refinement of machine-learned models.

In some examples, the advantages of the presently disclosed techniques can be realized by expending relatively little additional compute to further pretrain an already pretrained model. For example, the further pretraining process can be characterized by a second number of floating point operations (FLOPs) that is a minimal fraction—in some cases, less than or equal to one percent, such as less than or equal to 0.2 percent, or less than or equal to 0.1 percent—of a first number of FLOPs used during the initial pretraining. This level of computational efficiency can be particularly advantageous when working to align very large models that would otherwise require far more substantial computational resources to fine-tune. This efficiency can be expressed in terms of data consumption. For instance, example implementations of the present disclosure can achieve improvements by processing a second number of tokens that is less than or equal to one percent of a first number of tokens used in the initial pretraining phase (such as less than or equal to 0.2 percent, such as less than or equal to 0.1 percent).

A technical effect of example implementations of the present disclosure is more energy-efficient training operations or model updates. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

For example, by enabling further pretraining with a second number of FLOPs that is only a fraction of the original pretraining FLOPs, example implementations of the disclosed technique can provide a technical solution for increasing the performance of machine-learned models without proportional increases in energy use. Example experiments have demonstrated over 2× training cost reductions for achieving like performance by further pretraining according to the present disclosure as compared to continuing to pretrain using traditional methods.

Furthermore, the present disclosure offers a technical solution for extending the useful life of machine-learned models by enabling incremental improvements using existing datasets. This approach mitigates the need for the continuous collection and processing of large volumes of new data, which would otherwise result in increased wear and tear on hardware components, higher energy consumption, and greater heat generation. By improving the longevity and adaptability of machine-learned models through efficient further pretraining, the present disclosure provides a technical contribution that aligns with the objectives of sustainable computing and resource conservation.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Furthermore, pretraining a model according to example embodiments of the present disclosure can help provide a “universal” model effective to perform a variety of different downstream tasks with respect to sequenced data (e.g., the same or different sequenced data), optionally with or without subsequent fine-tuning. Traditional techniques, in contrast, point to model selection based on the downstream tasks. The plethora of distinct model arrangements, architectures, training recipes, training datasets, etc. can be overwhelming, leading to uninformed choices or otherwise suboptimal model implementations. Furthermore, even if a model may be appropriately selected for a given task, that model may need to be reconfigured or even replaced if the tasks or other requirements change. For example, traditional approaches to processing sequenced data have often relied on different categories of pretraining approaches. For instance, in the context of natural language processing, one prior approach includes pretraining with a language-modeling objective which unidirectionally generates sequences of text based on preceding textual content. Another approach includes pretraining with a masked language objective which identifies masked text based on surrounding text (e.g., bidirectionally). But these pretraining objectives have generally proved inadequate for diverse implementations: for example, open-text generation and prompt-based learning can be an unfavorable setting for traditional masked language objectives, whereas traditional language modeling approaches can be unduly inhibited by purely unidirectional causality.

Therefore, a unified approach according to example aspects of the present disclosure can provide for implementation of a small number models (e.g., one model) in place of many models (e.g., multiple models). This can decrease the computational complexity of deploying the models, training the models, updating the models, deactivating the models, etc. In this manner, for instance, decreased computational resources can be used to perform model operations with the unified techniques disclosed herein. Decreased storage can be used to store a small number of models (e.g., one model) in place of many models (e.g., multiple models). Decreased network transmissions can be used to implement a small number of models (e.g., one model) in place of many models (e.g., multiple models) on one or more remote device(s) (e.g., client devices connected to a server device). Efficiency of update and patch cycles can be improved by devoting resources (e.g., computational resources, human resources, etc.) to managing and versioning a small number of models (e.g., one model) in place of many models (e.g., multiple models). By using a model trained with a diversified pretraining approach according to example aspects of the present disclosure, a target performance can be achieved with less computational overhead by leveraging a small number of models (e.g., one model) in place of many models (e.g., multiple models). Lower latency can be achieved by using a small number of models (e.g., one model) instead of switching between many models (e.g., multiple models).

Furthermore, systems and methods according to example aspects of the present disclosure can provide for improved performance across task domains. For instance, a diversified pretraining approach according to example aspects of the present disclosure can provide for improved (e.g., more accurate, more precise, less expensive, less prone to error, etc.) processing of model inputs across task domains. For instance, in real-world deployment scenarios in which tasks may not necessarily be neatly categorized into separate domains, a model trained with a diversified pretraining approach according to example aspects of the present disclosure can provide for improved real-world performance and perform well in mixed or cross-domain tasks.

Furthermore, systems and methods according to example aspects of the present disclosure can provide for improved robustness from the diverse pretraining. For example, a model pretrained according to example aspects of the present disclosure with diverse pretraining objectives can provide for improved response in new or unfamiliar contexts based on the diverse exposure to different objectives in pretraining. For example, traditional adversarial attacks may be less effective when the model is less easily disrupted by different inputs. In this manner, additionally, for example, models pretrained with diverse objectives according to example aspects of the present disclosure can provide for improved robustness in real-world implementations in which tasks may not necessarily be neatly categorized or curated.

With reference now to the Figures, example embodiments of the present disclosure will be discussed in further detail.

### Example Devices and Systems

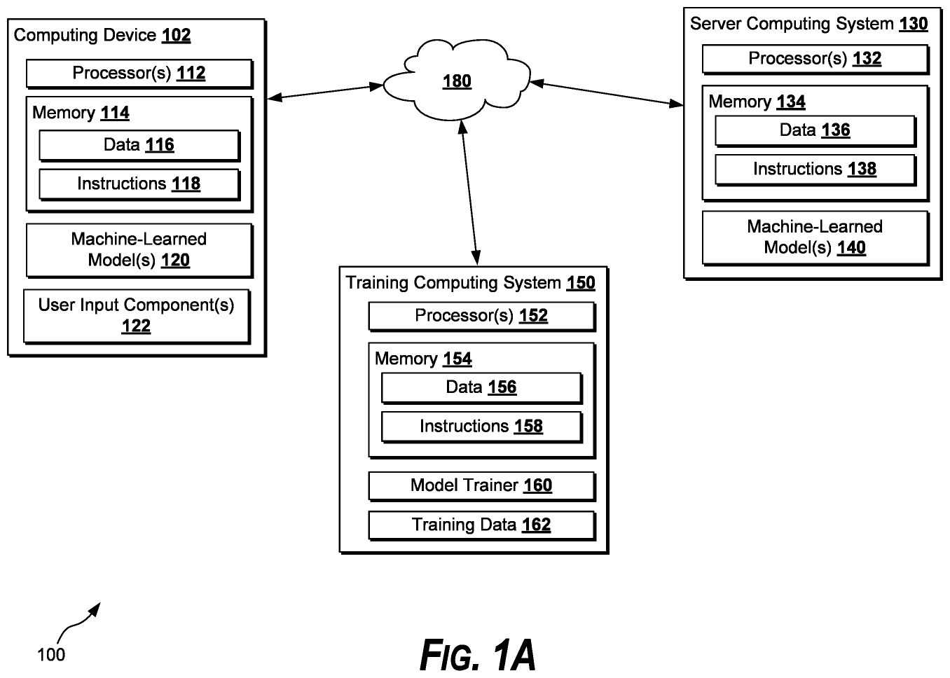

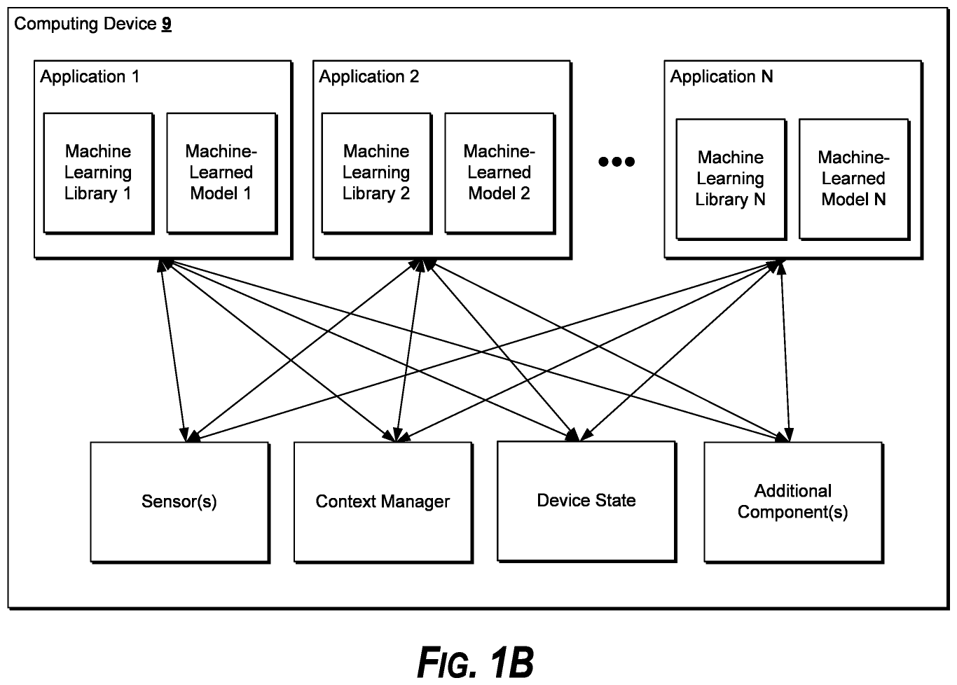

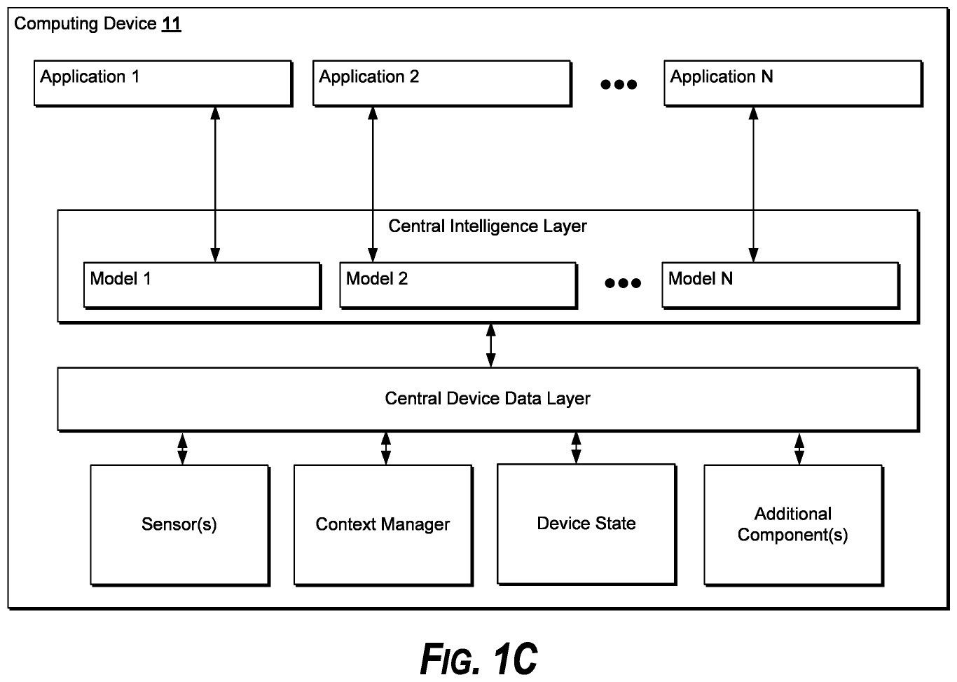

FIG. 1A depicts a block diagram of an example computing system 100 that can perform pretraining according to example embodiments of the present disclosure. The system 100 can include a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 can include one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which can be executed by the processor 112 to cause the user computing device 102 to perform operations.

In some implementations, the user computing device 102 can store or include one or more machine-learned models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120.

Additionally or alternatively, one or more machine-learned models 140 can be included in or otherwise stored and implemented by the server computing system 130 that communicates with the user computing device 102 according to a client-server relationship. For example, the models 140 can be implemented by the server computing system 130 as a portion of a web service (e.g., a service for processing data with the models). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 can include one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the models 120 and/or 140 based on a set of training data 162. The training data 162 can include, for example, supervised and/or unsupervised training data. In some embodiments, the training data includes sequenced data, such as sequences of data elements (e.g., textual data, such as words or other symbolic representations arranged in sequences, such as genetic information, natural language, etc.).

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output. As another example, the machine-learned model(s) can process the text or natural language data to generate a speech output (e.g., audio output).

In some implementations, the machine-learned model(s) can process the text or natural language data to generate a translation output. In some embodiments, the translation output can be in a different language than the text or natural language data. In some embodiments, the translation output can be in a different language than a set of training examples (e.g., pretraining examples). For instance, the machine-learned model(s) can provide optionally prompt-based zero-shot translation outputs.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 1B that performs according to example embodiments of the present disclosure. The computing device 1B can be a user computing device or a server computing device.

The computing device 9 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 1C that performs according to example embodiments of the present disclosure. The computing device 1C can be a user computing device or a server computing device.

The computing device 1C includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 1C.

The central intelligence layer can communicate with a central device data layer. The central device data layer can be a centralized repository of data for the computing device 1C. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Pretraining Pipeline Arrangements

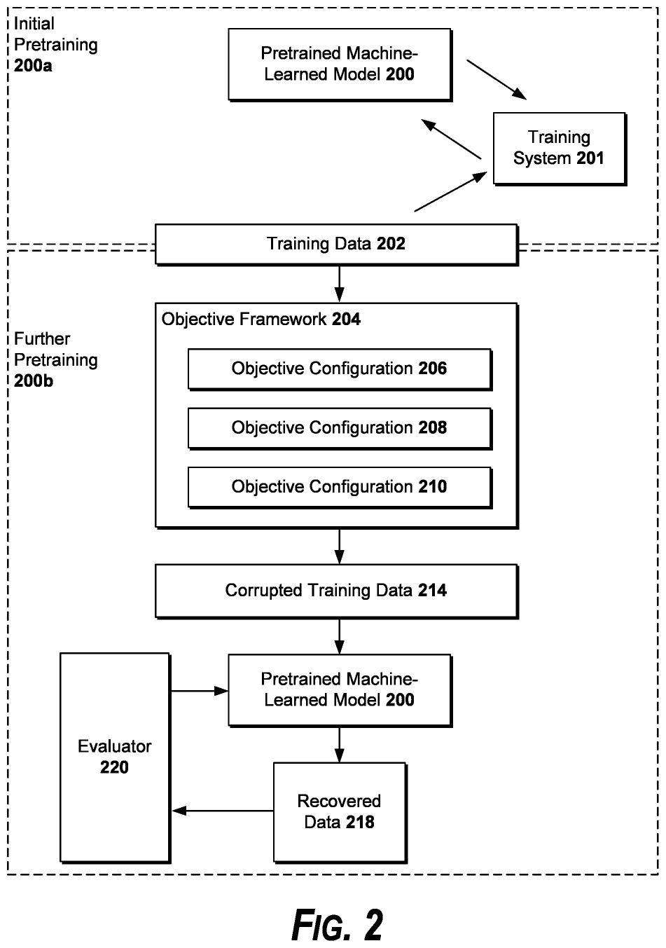

FIG. 2 depicts a block diagram of an example pretraining pipeline for performing further pretraining on a pretrained model that has undergone some initial pretraining. For example, in an initial pretraining pipeline 200a, pretrained machine-learned model 200 can be trained by a training system 201 using training data 202. In general, training system 201 can be a computing system configured to perform pretraining (e.g., unsupervised pretraining) on model 200 using training data 202.

The further pretraining pipeline 200b can be configured to process training data 202 using an objective framework 204. The objective framework 204 can provide for a plurality of configurations (e.g., objective configurations 206, 208, 210, etc.). Based on the plurality of objective configurations, corrupted training data 214 can be obtained for input to the pretrained machine-learned model 200 as a training example. The pretrained machine-learned model 200 can generate recovered data 218 and evaluator 220 can evaluate the performance of the machine-learned model 200 in recovering the corrupted training data 214. Based on the evaluated performance, one or more parameters of the machine-learned model 200 can be updated. In this manner, for instance, the pretrained machine-learned model 200 can be further pretrained, such as in a pretraining iteration that follows some initial pretraining regimen.

In general, corrupted training data 214 can include both corrupted and uncorrupted aspects of the training data 202. In this manner, for instance, one or more pretraining objective(s) can include attempting to recover and/or reconstruct corrupted aspects of the training data 202, providing for an unsupervised training objective.

The machine-learned model 12216 can be provided with the corrupted training data 214 to obtain as an output recovered data 218. The output recovered data 218 can be evaluated by evaluator 220 to determine one or more updates to the machine-learned model 12216 (e.g., updates to one or more parameters of the machine-learned model 12216).

In some embodiments, training examples of the training data 202 can include sequences of data elements (which can optionally be tokenized, such as for processing by, e.g., an encoder and/or decoder of a transformer model). In some embodiments, training examples can be subdivided into one or more subportions for generating corrupted training examples.

For example, in some embodiments, a plurality of corrupted training examples (e.g., for corrupted training data 214) can be generated from one or more training examples (e.g., of training data 202). In some embodiments, each training example of the one or more training examples includes a sequence of data tokens. In some embodiments, the plurality of corrupted training examples are respectively generated according to a plurality of configurations (e.g., objective configurations 206, 208, 210, etc.) of a pretraining objective framework (e.g., objective framework 204). In some embodiments, the plurality of corrupted training examples each include one or more corrupted subportions of a sequence of data tokens.

In some embodiments, the plurality of configurations can effectively interpolate between long-range generative language modeling objectives and local prefix-based modeling objectives. Advantageously, each of the plurality of object configurations can test the performance of the model 12216 in different ways. For example, bounding a model by bidirectional context (or the future) (e.g., span corruption) can make the task easier and can become more akin to fact completion. Meanwhile, language modeling objectives can be more open ended. This behavior can be observed, for example, by monitoring cross entropy losses of different objective configurations.

In some embodiments, a mode-switching or modal token can be added to the input to the machine-learned model 200 to signal the mode or paradigm of pretraining. For instance, it can be beneficial for the model 200 to not only distinguish between different objective configurations during pre-training but also to adaptively switch modes when learning downstream tasks. Modal tokens can advantageously facilitate mode switching. Mode switching can include associating pre-training tasks with dedicated sentinel tokens and can allow dynamic mode switching via discrete prompting.

The objective framework 204 can provide for selection from the plurality of objective configurations based on one or more parameter values. One parameter value can include a span length parameter. The span length parameter can be a mean span length parameter. For instance, a span length for a given corrupted training example can be sampled from a desired distribution (e.g., a normal distribution) with a mean set by the span length parameter. For sequence-based objectives, the span length parameter can be augmented by constraining the span to the end of the input sequence, such that no uncorrupted tokens appear after the corrupted span.

One parameter value can include a corruption rate. A corruption rate can indicate a probability of subportions of a span being corrupted. For instance, a corruption rate can be expressed as a percentage, fraction, etc.

One parameter value can include a quantity of spans. The quantity of spans can be a function of the length of the original input. The quantity of spans can be a function of the span length or mean span length. For instance, the quantity of spans can be determined based on computing the result of the input length divided by the span length.

Parameterizing the objective framework based on the span length, corruption rate, and quantity of spans can provide for multiple different objective configurations that can interpolate among different types of learning objectives. As an example, to construct an objective analogous to causal language modeling using this formulation, one could set the span length to the length of the input span, a corruption rate of 100%, and the quantity of spans to 1 (e.g., a single corrupted span with its span length equal to the length of the input sequence). To express one similar to prefix-based language modeling objective, one could set the span length to the difference between the input sequence length and a prefix length and the quantity of spans to a single, post-prefix span, with the additional constraint that the single corrupted span reaches the end of the sequence. The corruption rate can be set at, for example 100% minus the ratio of the prefix length to the input span length.

Multiple different objective configurations can be used. For instance, a first objective configuration can be used for training example. A second objective configuration can be used for a second training example. A third objective configuration can be used for a third training example. Alternatively, multiple different objective configurations can be used for each training example.

An example mixture of objective configurations is described herein with respect to three different types or classes of configurations. The first two types or classes of configurations that follow can be considered distributed configurations, in that they can be configured for generating multiple corrupted spans distributed across the input sequence (e.g., randomly distributed). The third type or class can be considered a sequential configuration, in that it can be configured for generating a corrupted span in a particular sequence (e.g., a sequence of uncorrupted input followed by a single span of corrupted input).

A first objective configuration can be a configuration that implements relatively short corrupted spans. The first objective configuration can include relatively short corrupted spans with relatively low corruption rates. The first objective configuration can be similar to “regular” span corruption objectives, such as introduced by Colin Raffel, Noam Shazeer, Adam Roberts, Katherine Lee, Sharan Narang, Michael Matena, Yanqi Zhou, Wei Li, & Peter J Liu, Exploring the limits of transfer learning with a unified text-to-text transformer, arXiv preprint arXiv: 1910.10683, 2019. An example first objective configuration can include parameters to use 2 to 5 tokens as the span length, or less than 10 tokens, and corrupting 15% of input tokens. A first objective configuration can be a mild corruption configuration.

A second objective configuration can be a configuration that implements more extreme corruption. The second objective configuration can include longer spans for corruption. The second objective configuration can include higher corruption rates. For instance, an example second objective configuration can include spans for corruption of length greater than 12 tokens. In some examples, approximately half the input can be portioned apart for corruption. An example second objective configuration can include a corruption rate of greater than 30%, such as 50% or greater.

A third objective configuration can be a configuration that implements relatively long-form language generation. The third objective configuration can be a sequence-based objective. The third objective configuration can be set up to provide for a predetermined sequential ordering of uncorrupted and corrupted spans. For instance, the third objective configuration can provide a prefix-based language modeling task. The third objective configuration can partition the input sequence into two sub-sequences of tokens as context and target such that the targets do not rely on future information.

A further pretraining pipeline 200b can leverage any one or more of objective configurations from the three different classes. A further pretraining pipeline 200b can implement all three classes of objective configurations. A further pretraining pipeline 200b can implement one or more objective configurations from each of the three classes. For instance, multiple sets of configuration parameters can be used within each class. For instance, the mild class of objectives can be implemented with a span length of three and a span length of 8 together (e.g., in parallel), both with a corruption rate of 15%. The more extreme class of objectives can be implemented with a span length of three, a span length of 8, a span length of 64 (all with a corruption rate of 50%) and a span length of 64 with a corruption rate of 15%. The sequence-based class of objectives can be configured with a variety of span lengths, such as one-quarter of the input sequence length, with a corruption rate of 25%. In this manner, for instance, each class can be implemented in different configurations in parallel to train model 200. For instance, all seven of the examples provided above can be used during training of model 200.

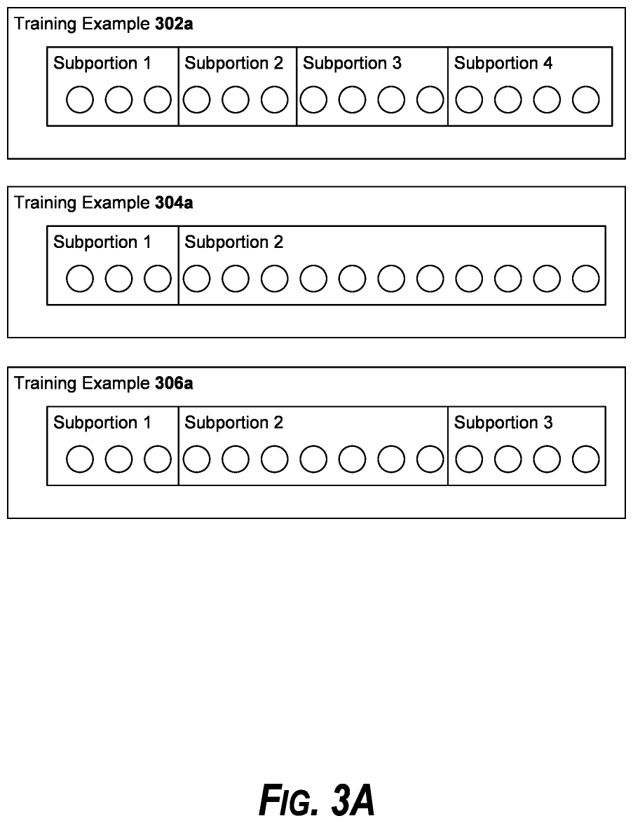

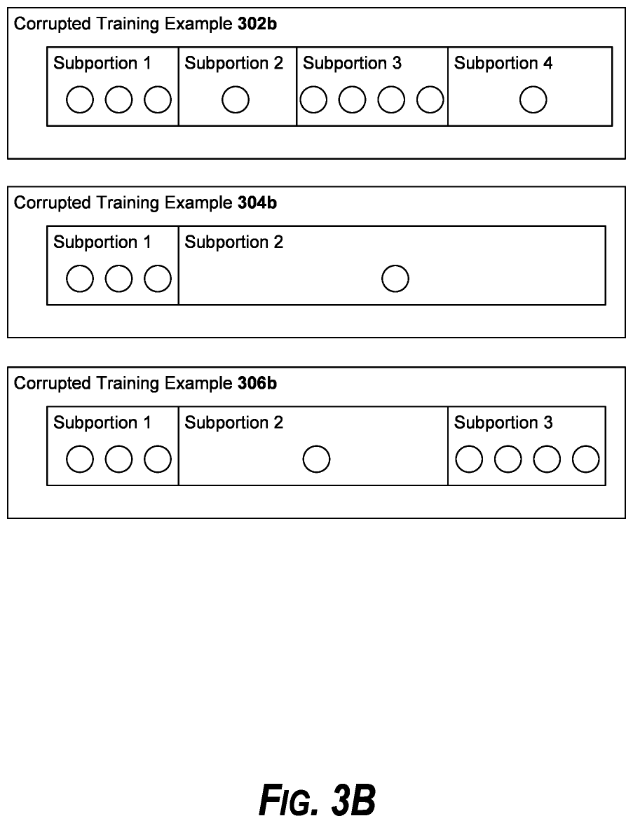

In FIG. 3A, a block diagram of training examples 302a, 304a, and 306a illustrates a plurality of training examples subdivided into subportions. The subportions each contain one or more data elements (e.g., tokens). According to the plurality of configurations (e.g., objective configurations 206, 208, 210, etc.), one or more subportions of the training examples 302a, 304a, 306a, can be selected for corruption. For instance, the training examples can be subdivided based on a configuration parameter of the objective framework characterizing a count of subportions and/or characterizing a span length of subportions (e.g., a quantity of tokens/elements for a subportion). Once one or more subportions are selected for corruption, a corruption rate configuration parameter can characterize a likelihood of the subportion being corrupted.

FIG. 3B depicts a plurality of corrupted training examples 302b, 304b, 306b. The corrupted training examples 302b, 304b, and 306b can be derived from the same or different uncorrupted training examples from the training data 202 (e.g., optionally corresponding to training examples 302a, 304a, 306a). Each of the corrupted training examples 302b, 304b, and 306b can include one or more selected subportions for corruption. In some embodiments, at least one subportion of each of the corrupted training examples 302, 304, and 306 can be corrupted. For instance, subportions 2 and 4 of corrupted training example 302 might be corrupted (although other subportions can also be corrupted in addition to or instead of subportions 2 and 4). For instance, subportion 2 of corrupted training example 304 might be corrupted (although other subportions can also be corrupted in addition to or instead of subportion 2). For instance, subportion 2 of corrupted training example 306 might be corrupted (although other subportions can also be corrupted in addition to or instead of subportion 2). As illustrated, in some embodiments, a corrupted subportion can be replaced with a corrupted token (e.g., optionally a distinct token for each corrupted subportion).

In this manner, for example, the machine-learned model 12216 can learn to recover the corrupted subportions by processing the corrupted subportions (e.g., processing replacement or altered token(s) for the subportion).

Corrupted training examples 302, 304, and 306 can be corrupted according to the same objective configuration. Each of corrupted training examples 302, 304, and 306 can be corrupted according to different objective configurations. Each of corrupted training examples 302, 304, and 306 can be corrupted according to a battery of objective configurations, such as each of a set of configurations.

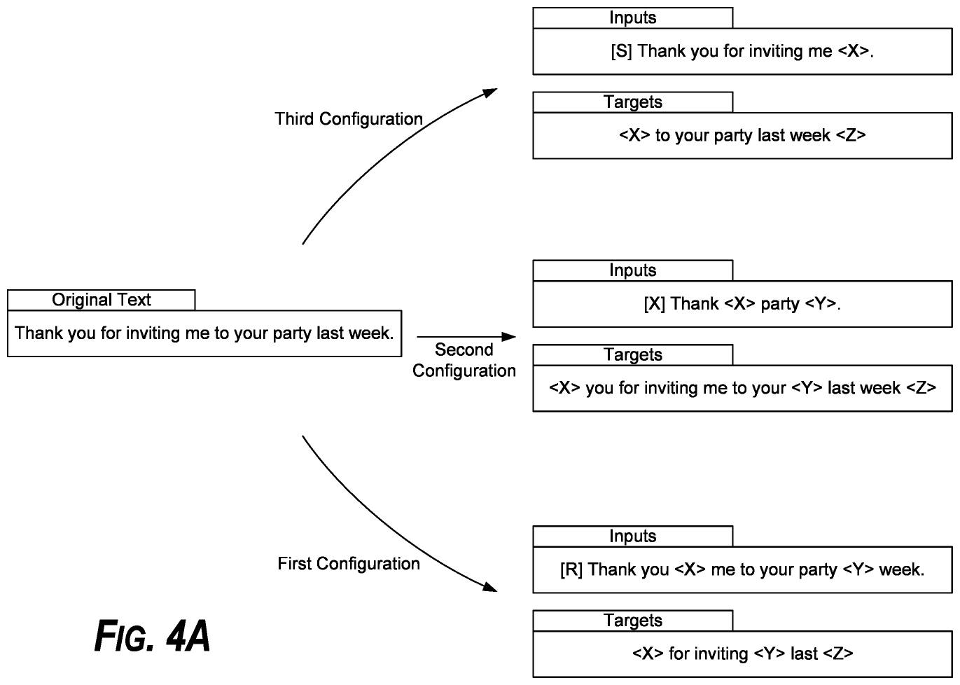

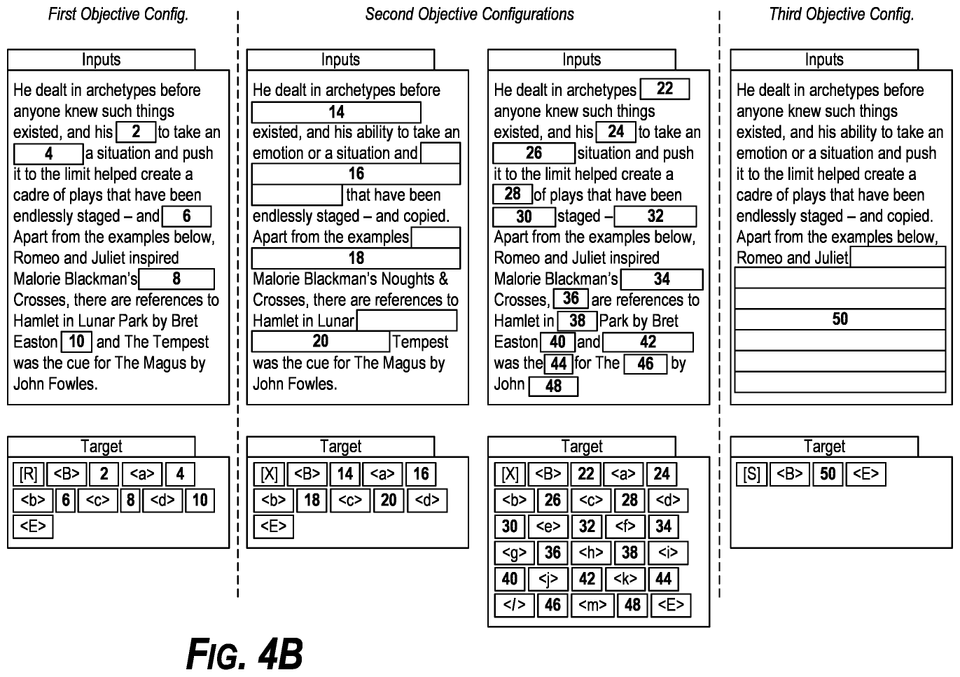

FIG. 4A depicts one illustration of how a training example can be broken out into a plurality of corrupted training examples based on a plurality of configurations of an objective framework.

Under a first objective configuration, for instance, original text “Thank you for inviting me to your party last week” can be corrupted as “Thank you <X> me to your party <Y> week” where <X> and <Y> are optionally distinct replacement tokens, such that the machine-learned model can target obtaining “for inviting” for <X> and “last” for <Y>. This can be can example of a mild objective configuration.

In a second, more extreme objective configuration, for instance, the original text can be corrupted as “Thank <X> party <Y>” where <X> and <Y> are optionally distinct replacement tokens, such that the machine-learned model can target obtaining “you for inviting me to your” for <X> and “last week” for <Y>.

In a third objective configuration, the original text can be corrupted as “Thank you for inviting me <X>.” where <X> is a replacement token, such that the machine-learned model can target obtaining “to your party last week” for <X>. This can be an example of a prefix-based language modeling objective.

In some embodiments, configuration parameters of the objective framework can be selected to interpolate between, for example, language modeling objectives (e.g., to unidirectionally predict subsequent word(s) based on preceding word(s)) and in-place reconstruction (e.g., fill in gaps bidirectionally based on surrounding context). For instance, as the corrupted subportion length increases, the objective can, in some embodiments, approximate a language modeling objective locally within the corrupted subportion. Accordingly, a diverse mixture of pretraining objectives can be generated by implementing a plurality of configurations of a pretraining objective framework according to example aspects of the present disclosure.

In some embodiments, a modal token can be added to the input to the machine-learned model 12216 to signal the mode or paradigm of pretraining. For instance, in FIG. 4A, “[R]” can indicate a modal token indicating a “regular” or “mild” class objective. “[X]” can indicate a modal token indicating a more extreme class objective. “[S]” can indicate a modal token indicating a sequence-based language modeling objective. The modal tokens can be used during pretraining, during fine-tuning, and during downstream tasks. In this manner, for instance, “mode-switching” can be invoked at inference time to engage a relevant operational mode of the trained model.

FIG. 4B illustrates an example application of a mixture of objective configurations to the same input sequence. For a first objective configuration, relatively few subportions 2, 4, 6, 8, and 10 are selected for corruption. As shown in FIG. 4B, the target for prediction by model 200 is initiated with the modal token “[R]” indicating a regular or more mild class of objective configuration. For instance, the mean span length of the subportions 2, 4, 6, 8, and 10 can be, for instance, around 5. Sampled span lengths can be, in one example, 3, 5, 4, 5, and 2, respectively.

The symbols “<{letter}>” can be all the same or individually selected (e.g., individually different) and can be used to index the subportions 2, 4, 6, 8, and 10. For instance, the target can be input to the model 200 (e.g., to a decoder component of the model) to trigger prediction of the original tokens corresponding to the corrupted spans indicated in the target. For instance, a placeholder token “<a>” can be associated (e.g., distinctly associated) with subportion 4. The input can include a placeholder token corresponding to “<a>” in lieu of the subportion 4. Thus the model 200 can be configured to predict based on processing “<a>” that subportion 4 follows. Accordingly, the target can be used to guide the model 200 toward predicting an output sequence that contains the corrupted subportions delimited by the corresponding placeholder token(s). For instance, for the first objective configuration, an example output can be “<B> ability <a> emotion or <b> copied. <c> Noughts & <d> Ellis, <E>.” In this manner, for instance, example implementations can effectively provide a fill-in-the-blank solution to masked-out subportions of the input sequence.

For a second objective configuration, multiple sets of configuration parameters can be used. For instance, in a first set of configuration parameters (left column), the mean span length can be longer (e.g., 20 tokens, 30 tokens, 40 tokens, etc.). The span quantity can be relatively low. For instance, spans 14, 16, 18, and 20 can be selected for corruption. Individual sampled span lengths can be, in one example, 16, 32, 24, and 24, respectively. In a second set of configuration parameters (right column), the mean span length can be shorter (e.g., 3 tokens, 5 tokens, 8 tokens, etc.). The span quantity can be relatively higher. For instance, spans 22, 24, 26, 28, 30, 32, 34, 36, 38, 40, 42, 44, 46, and 48 can be selected for corruption. Individual sampled span lengths can be, in one example, 3, 3, 5, 4, 4, 5, 5, 3, 3, 2, 4, 4, 2, 4, and 5, respectively. As shown in FIG. 4B, the target for this example configuration is initiated with the modal token “[X]” indicating a more extreme class of objective configuration.

For a third objective configuration, a sequence-based objective can be used. A single, longer span 50 can be selected for corruption. For instance, the span length can be 95. The span can be anchored to the end of the input sequence. As shown in FIG. 4B, the target for this example configuration is initiated with the modal token “[S]” indicating a sequence-based class of objective configuration.

Further example details of example objectives are described in U.S. Provisional Application No. 63/305,910, which is hereby incorporated by reference herein in its entirety.

Although example implementations are described herein with respect to text data, it is to be understood that the techniques can be applied to various other types of training data. In particular, data that can be sequentialized and tokenized can be processed using example implementations of this technique. Various types of sequence-based data can be used.

In an example, image data can be used. Image examples can be noised or corrupted in a manner analogous to the corruption of text data in natural language processing tasks. The technique can enhance a model's ability to understand and interpret visual information by exposing it to a diverse set of pretraining objectives.

In an example application to image data, the pretraining objective framework can be used to generate corrupted image examples from an existing pretraining dataset of images. These corrupted examples can be created by applying various forms of manipulation or “corruption” to the original images. The manipulations can simulate occlusions, distortions, or other types of noise that the model must learn to interpret or correct. By training on these corrupted examples, the model can develop robust feature extraction and pattern recognition capabilities, improving its performance on downstream tasks such as image classification, object detection, or image segmentation.

For example, in a first set of corrupted image examples, small regions of the image (e.g., patches or segments) can be occluded with placeholders such as solid color blocks or noise patterns. The model can then trained to predict or reconstruct the occluded regions. A second set of corrupted image examples could involve more extensive occlusions, such as covering larger portions of the image or entire objects within the image.

For example, in a first set of corrupted image examples, the corruption can involve adding low levels of visual noise (e.g., Gaussian noise, salt-and-pepper noise) to the images, while the second set could include images with higher levels of noise that significantly degrade the visual quality.

For example, in a first set of corrupted image examples, images can be slightly downsampled or blurred, simulating a mild corruption, whereas the second set could include images that are heavily downsampled or blurred, making the task of recognizing features much more challenging.

Example test results of example implementations of the present disclosure are provided below.

### Example Results

Example results are reported herein for the sake of example only. For ease of reference, example implementations of models prepared according to aspects of the present disclosure are labeled “U-PaLM.” An example implementation of the further pretraining pipeline is referred to as “UL2R.”

U-PaLM is initialized from PaLM and leverages the same architecture. Aakanksha Chowdhery, Sharan Narang, Jacob Devlin, Maarten Bosma, Gaurav Mishra, Adam Roberts, Paul Barham, Hyung Won Chung, Charles Sutton, Sebastian Gehrmann, et al. Palm: Scaling language modeling with pathways. arXiv preprint arXiv:2204.02311, 2022. This section describes the training procedures of UL2R and how they are applied to continue training PaLM. U-PaLM was trained with the same data mixture as PaLM and do not rely on additional sources of data (labeled or unlabeled). In this architecture, U-PaLM uses a total combined sequence length of 2048 (e.g., PaLM's sequence length) which is then split to 1024 inputs and 1024 targets. U-PaLM is configured to concatenate prefix and target before applying any additional padding. Packing, trimming and padding is then subsequently applied later after the prefix has been concatenated with the targets.

The UL2R pipeline includes of three types of corruption objectives: Regular denoising whereby the noise is sampled as spans, replaced with sentinel tokens (Spans are typically uniformly sampled with a mean of 3 and a corruption rate of 15%); Sequential denoising (e.g., PrefixLM), and Extreme denoising whereby the noise is increased to relatively ‘extreme’ amounts in a significant percentage of the original text (by span length or corruption rate; Spans are typically uniformly sampled with a mean length of 32 OR a corruption rate of up to 50%).

For U-PaLM, a mixture of 50% PrefixLM, 25% Long (extreme) span corruption, and 25% regular span corruption were used. Mode prompting tokens were used, with [S2S] for S-denoisers (PrefixLM), [NLU] for R-denosiers and [NLG] for X-denoisers.

The 540B model was trained for a total of 20 k steps with a batch size of 32. The total number of extra tokens trained on for the 540B model was approximately 1.3 Billion which constitutes 0.16% extra computation, since the original PaLM model was pretrained on 780B tokens. A cosine learning rate decay schedule was used that anneals the learning rate from 10⁻⁴ to 10⁻⁶. U-PaLM 8B and 62B models were trained using 64 TPUv4 chips. Training an U-PaLM 540B model only consumed 512 TPUv4 chips and finishes in about 5 days.

In this experiment, the results show improved scaling curves from small amounts of UL2R training on top of both PaLM 8B and PaLM 540B. Downstream metrics and few-shot evaluation are used since (1) this is closer to usability of these models and (2) loss with UL2 and causal language modeling is not always comparable. The experiments included initializing and training multiple U-PaLM models using different PaLM intermediate checkpoints. On the 8B model, this was repeated 7 times at different intervals. Given that the 540B model was more computationally demanding, the experiments included 3 points. For evaluation, the average score of NLU and NLG tasks from the GPT-3 suite [Brown et al., 2020] was used. In total the experiments use 26 tasks (e.g., TriviaQA, NaturalQuestions, SuperGLUE, PIQA, OpenbookQA, ANLI etc).

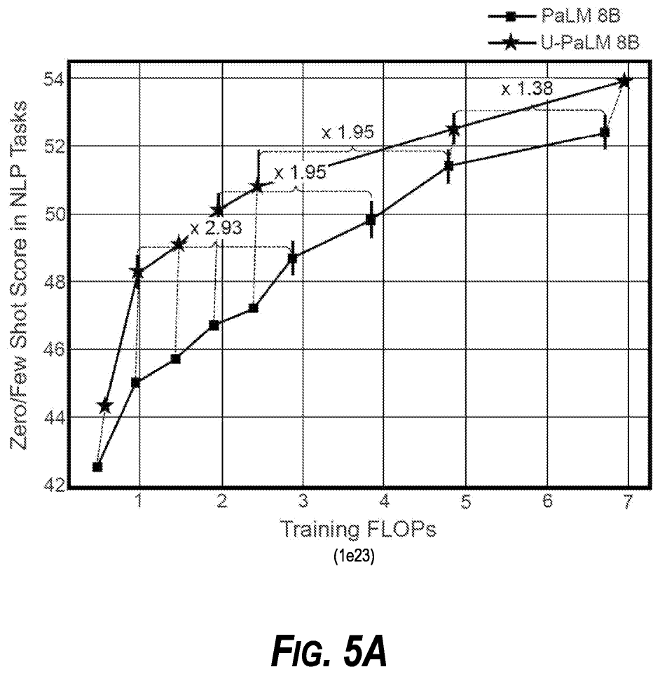

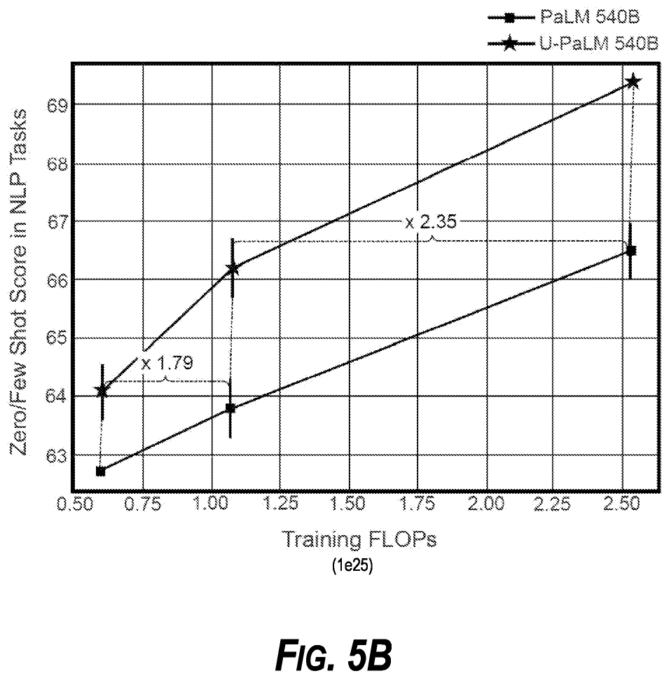

FIGS. 5A and 5B show that U-PaLM substantially outperformed the original PaLM models both at 8B scale and 540B scale. Note that the dotted lines represent a pathway before and after UL2R training. These results show that UL2R training improves the scaling curve of PaLM substantially, i.e., UL2R provides a more compute-efficient performance improvement compared to training the original PaLM models for longer with the standard causal language modeling objective.

Savings Rate: At a certain stage of training, a model developer has an option to continue training for K more steps using the standard causal language modeling objective or applying UL2R for a small amount of steps. The experiments explored the counterfactual savings rate of choosing UL2R as opposed to continuing training with causal language modeling. For the 540B model, the saving rate at the middle checkpoint is approximately 2×. This is equivalent to about 4.4 million TPUv4 hours for the 540B model. For the 8B model, the saving rate tended to be lowest at both the start and convergence of the model. It appeared to be higher at middle stages of training (relative to convergence) which may show that the utility of UL2R changes with respect to the amount of causal language modeling training already done. For the 540B model, since the PaLM model was not trained to convergence and the number of tokens to parameters ratio is relatively low, the savings rate could still be increasing even beyond 2.35× (such as 3×, 4×, 5×, 10×, 20×, etc.).

Table 1 reports the results of PaLM 540B and U-PaLM 540B on the BigBench emergent suite as inspired by the criterion set by Wei et al. [2022a]. Note that some tasks use a conjunction of various ‘skills.’ For example, the navigate task is a combination of spatial reasoning and arithmetic (counting). U-PaLM outperforms PaLM on 19 out of the 21 tasks at 540B scale. Moreover, the gains on certain tasks are substantial (e.g., 55.3%->67.0%) on navigate and 69.1%->86.1% on snarks). On average, there is a +5.4% relative quality gain on the un-normalized aggregated average across all 21 tasks.

TABLE 1

| | reasoning | PaLM | U-PaLM | |
|---|---|---|---|---|
| task | type | 540B | 540B | Change |
| navigate | arithmetic, | 55.3 | 67 | (+21.2%) |
| | logical | | | |
| strategyqa | multi-step | 73.9 | 78.3 | (+6.0%) |
| crass_ai | commonsense | 97.7 | 100 | (+2.4%) |
| logical_sequence | commonsense | 92.3 | 86.5 | (−6.7%) |
| vitaminc_fact_{—} | contextual, | 70.2 | 73.9 | (+5.3%) |
| verification | commonsense | | | |
| understanding_{—} | commonsense | 75.7 | 78.4 | (+3.6%) |
| fables | | | | |
| identify_odd_{—} | analogical | 87.2 | 87.5 | (+0.3%) |
| metaphor | | | | |
| hyperbaton | contextual QA | 54.2 | 59.9 | (+10.5%) |
| causal_judgment | causal and | 65.3 | 68.4 | (+4.7%) |
| | commonsense | | | |
| english_proverbs | commonsense, | 91.2 | 87.5 | (−4.2%) |
| | contextual QA | | | |
| geometric_shapes | algorithmic, | 44 | 49.3 | (+12.0%) |
| | visual | | | |
| physics_questions | logical, | 7.6 | 12.5 | (+64.5%) |
| | physics, math | | | |
| snarks | commmonsense | 69.1 | 86.1 | (+24.6%) |
| analogical_{—} | analogical | 36.5 | 37.5 | (+2.7%) |
| similarity | | | | |
| international_{—} | reading | 65.9 | 68 | (+3.2%) |
| phonetic_{—} | comprehension | | | |
| alphabet_nli | | | | |
| movie_dialog_{—} | commonsense, | 64.8 | 68.8 | (+6.2%) |
| same_or_{—} | reading compre. | | | |
| different | | | | |
| timedial | commonsense, | 78.3 | 81.2 | (+3.7%) |
| | logical | | | |
| question_selection | reading | 54.8 | 59.8 | (+9.1%) |
| | comprehension | | | |
| logical_fallacy_{—} | logical | 80.3 | 81.4 | (+1.4%) |
| detection | reasoning | | | |
| unit_{—} | arithmetic, | 47 | 51 | (+8.5%) |
| interpretation | logical | | | |
| language_{—} | multilingual | 36 | 38.9 | (+8.1%) |
| identification | | | | |
| average (21 tasks) | | 64.3 | 67.7 | (+5.3%) |

UL2R unlocks emergent task performance at smaller scales. Scale (e.g., scaling to 540B) is known to be one factor that results in emergent task performance [Wei et al., 2022a]. UL2R has demonstrated ability to elicit emergent abilities at smaller scales. For example, certain tasks such as crass_ai, vitaminc, identify_odd_metaphors are tasks where performance starts to spike at 62B scale (as opposed to only at 540B with the PALM model). In rarer occasions, the performance of U-PaLM 8B is even higher than PaLM 62B (e.g., snarks, understanding_fables).

Qualitative Analysis: New Prompting Capabilities: Left-to-right casual language model pretraining has typically allowed models to provide meaningful continuations of prompts. With U-PaLM it is observed that, by extending pretraining with a small amount of UL2 denoising steps, the model is also able to pick up infilling abilities—where the model is given a location in the middle of a prompt to fill in. Notably, with U-PaLM it can be possible to query both the infill style and the traditional style via the usage of extra ID tokens (as it is used in denoising) or without, respectively.

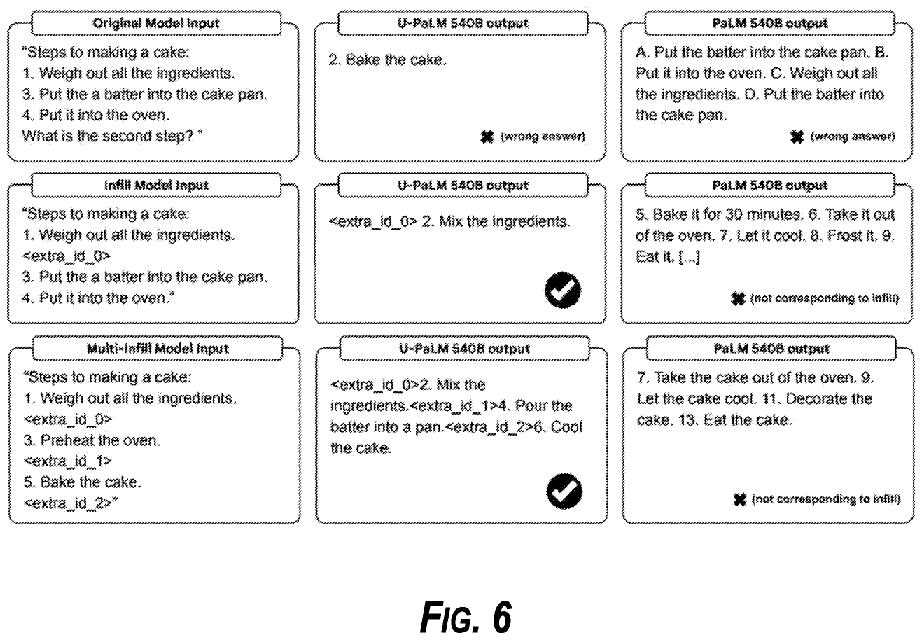

In FIG. 6, an example is included with example outputs for PALM, U-PaLM with traditional prompting, as well as U-PaLM with infill prompting. The prompt is phrased in two ways: one as a question that is suitable for traditional prompting via PaLM and one leveraging U-PaLM's infill capabilities. In the traditional phrasing, both PaLM and U-PaLM do not produce the correct answer. With the infill phrasing, PaLM ignores the infill token (extra ID token) as PaLM has not seen it during training, and instead produces the rest of the steps after step 4. U-PaLM correctly infills the second step in this example. Finally, a third example is included to demonstrate U-PaLM's ability to infill multiple slots. These examples demonstrate that, with only a small amount of additional training, U-PaLM has expanded over the functionality of PaLM to serve an entirely new class of queries.

During training of U-PaLM, R-, X-, and S-denoisers were associated with the [NLU], [NLG], and [S2S] mode tokens respectively. S-denoisers were essentially the PrefixLM objective, while R- and X-denoisers were variations of span corruption, and thus are also associated with extra ID tokens which can be used during prompting for infill (as shown above). In some tests, using different tokens returned different results. For instance, a challenging example includes an example in which the model was asked to do zero-shot cross-lingual question answering from an English question into a Vietnamese answer. For PALM and U-PaLM default, the test passed the input as-is to the model. For the rest, the test prepended one of [S2S], [NLU], or [NLG] to the beginning of the input, and in the case of [NLU] and [NLG], the test added the infill token at the end of the input. U-PaLM in [S2S] mode is the only variant that returns the correct answer in Vietnamese. This may be due to the association of the task and the sequence-to-sequence pretraining objective in PrefixLM, allowing the model to leverage particular understandings learned in that mode. Regular PaLM produced the correct answer in the wrong language, while U-PaLM with default prompting (no mode, no infill) produces a roughly correct answer but could be more specific.

### Example Methods

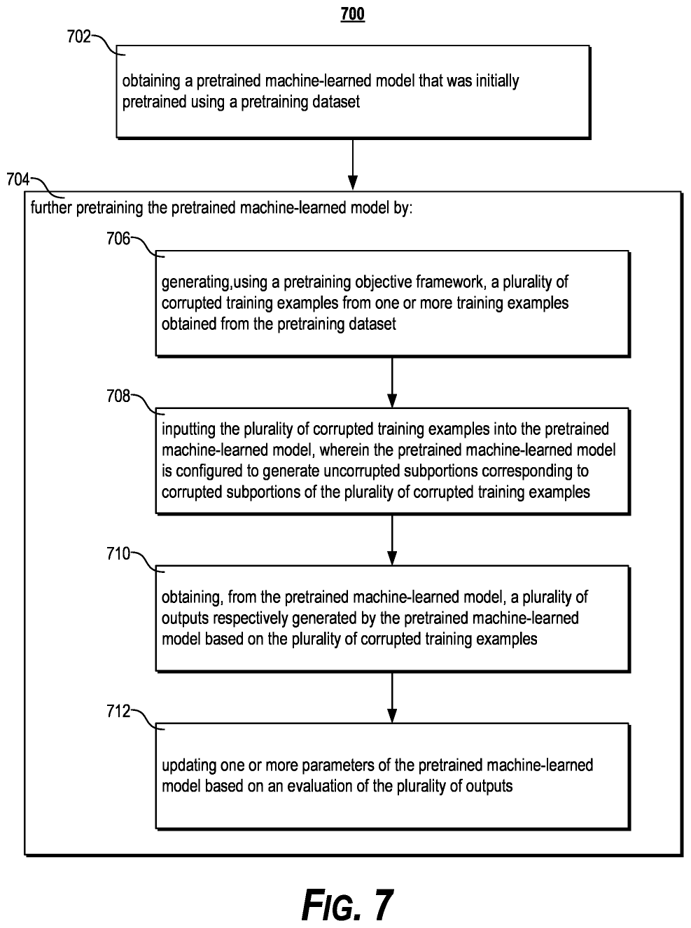

FIG. 7 depicts a flowchart of a method 700 of improving the performance of a pretrained a machine-learned model by further pretraining with diverse objectives. For instance, an example machine-learned model can include a pretrained model 200.

One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining, by a computing system including one or more processors, a pretrained machine-learned model that was initially pretrained using a pretraining dataset. In an example, the pretrained machine-learned model includes a model 120, 140, 200, etc. In some examples, this model has undergone an initial pretraining phase using the pretraining dataset. The initial pretraining phase can use any variety of pretraining objectives. In some implementations of example method 700, the initial pretraining was based on a causal language modeling objective. In some implementations of example method 700, the initial pretraining was based on one of more objectives consisting essentially of a causal language modeling objective.

The pretrained model can be sourced from an internal repository of models or obtained from an external source. The pretrained model can be a new instance of a model initialized using the parameter values obtained using the initial pretraining. The pretrained model can be an existing instance of a model.

At 704, example method 700 can include further pretraining the pretrained machine-learned model. This further pretraining can be accomplished using a pretraining objective framework that implements diverse training objectives to perform training with a range of inductive biases. This variety can facilitate a variety of new learning experiences for the model, even without obtaining new dataset(s).

Further pretraining can include, at 706, generating, by the computing system and using a pretraining objective framework, a plurality of corrupted training examples from one or more training examples obtained from the pretraining dataset. The generation of these corrupted training examples can utilize different configurations within the pretraining objective framework to induce diverse learning patterns in the model. For example, the plurality of corrupted training examples can include a first set of one or more training examples corrupted according to a first set of configuration parameters of the pretraining objective framework (e.g., objective configuration 208). The plurality of corrupted training examples can include a second set of one or more training examples corrupted according to a second set of configuration parameters of the pretraining objective framework (e.g., objective configuration 210). For instance, the first set of configuration parameters might specify a certain span length and corruption rate for text sequences, while the second set might involve different span lengths and higher corruption rates, challenging the model with more severely altered data.

Further pretraining can include, at 708, inputting, by the computing system, the plurality of corrupted training examples into the pretrained machine-learned model. For example, the pretrained machine-learned model can be configured to generate uncorrupted subportions corresponding to corrupted subportions of the plurality of corrupted training examples. For instance, the pretrained machine-learned model can be configured to predict the content that was originally in the training example that was obscured in the corruption process. In this manner, for instance, the model can “denoise” the training example by removing noise that was added by the objective framework 204.

Further pretraining can include, at 710, obtaining, by the computing system and from the pretrained machine-learned model, a plurality of outputs respectively generated by the pretrained machine-learned model based on the plurality of corrupted training examples. For instance, the outputs can include content predicted to replace the corrupted portions. The outputs can include predictions of the original data in the training example.

Further pretraining can include, at 712, obtaining, updating, by the computing system, one or more parameters of the pretrained machine-learned model based on an evaluation of the plurality of outputs. For example, an evaluation can include comparing the output predictions to the original data or evaluating other metrics associated with the outputs (e.g., repetitiveness, flow, fluency, grammatical correctness, etc.). In an example, an evaluation can provide a score. The score can be used to compute updates to the model parameters to increase a likelihood of future outputs have a better score (e.g., less error, improved quality, etc.). For example, the score can be backpropagated through the model to determine how changes to model parameters would be expected to affect the score (e.g., the gradient of the score with respect to the parameter). The parameters can be updated in a direction that corresponds to improving the score.

In some implementations of example method 700, the one or more training examples were already used during the pretraining of the pretrained machine-learned model. For example, the pretraining dataset can include a corpus of training data (e.g., text-based training data). One or more training examples can include snippets of text that were extracted from the corpus, trimmed to fit an input dimension of the model, and otherwise prepared for processing. This preparation can be re-used by using the same training examples. In this manner, for instance, the pre-processing operations need not be performed anew in some implementations.

For instance, if the pretrained model was originally trained using a dataset including various text passages for language understanding tasks, the same text passages can be re-employed during the further pretraining stage. However, instead of presenting the text in the same manner as during the initial training, these passages can be altered according to the diverse pretraining objectives set forth by the pretraining objective framework (e.g., at 706). This can not only conserve data resources but also imbue the model with an ability to extract and generalize knowledge from a dataset it has already encountered, potentially leading to enhanced performance and robustness across a broader spectrum of tasks.

The reutilization of training examples from the initial pretraining phase in the further pretraining stage can be particularly advantageous in scenarios where data is scarce or expensive to collect. For example, in domain-specific applications where new data may be limited, or in cases involving languages or dialects with fewer resources, the ability to repurpose existing training examples can significantly benefit the continued development and refinement of machine-learned models.

Moreover, the process of reintroducing previously used training examples with varied corruption configurations can introduce a level of complexity that encourages the model to develop a deeper understanding of the underlying data. For example, a text passage that was initially used for a left-to-right, causal learning task during initial pretraining could be reintroduced with certain words or phrases masked or replaced in different configurations (e.g., at 706). The model, having already learned a baseline understanding of the knowledge contained in the passage, can be challenged anew to apply its understanding based on these varied inputs. Such a method can build a more robust world understanding, leading to a more nuanced comprehension of context and relationships within the text.

In some examples, the advantages of the presently disclosed techniques can be realized by expending relatively little additional compute to further pretrain an already pretrained model. The additional compute can be measured in terms of floating point operations (FLOPs) to be performed in training. In some implementations of example method 700, the pretrained machine-learned model was initially pretrained using a first number of floating point operations (FLOPs).

In some implementations of example method 700, the further pretraining is characterized by a second number of FLOPs that is less than or equal to 10 percent of the first number. In some implementations of example method 700, the further pretraining is characterized by a second number of FLOPs that is less than or equal to 5 percent of the first number. In some implementations of example method 700, the further pretraining is characterized by a second number of FLOPs that is less than or equal to 1 percent of the first number. In some implementations of example method 700, the further pretraining is characterized by a second number of FLOPs that is less than or equal to 0.5 percent of the first number. In some implementations of example method 700, the further pretraining is characterized by a second number of FLOPs that is less than or equal to 0.4 percent of the first number. In some implementations of example method 700, the further pretraining is characterized by a second number of FLOPs that is less than or equal to 0.3 percent of the first number. In some implementations of example method 700, the further pretraining is characterized by a second number of FLOPs that is less than or equal to 0.2 percent of the first number. In some implementations of example method 700, the further pretraining is characterized by a second number of FLOPs that is less than or equal to 0.1 percent of the first number. In some implementations of example method 700, the further pretraining is characterized by a second number of FLOPs that is less than or equal to 0.05 percent of the first number.

In some examples, the advantages of the presently disclosed techniques can be realized by expending relatively little additional compute to further pretrain an already pretrained model. The additional compute can be measured in terms of training data tokens to be processed in training. In some implementations of example method 700, the pretrained machine-learned model was initially pretrained using a first number of tokens from the pretraining dataset.

In some implementations of example method 700, the further pretraining is characterized by a second number of tokens that is less than or equal to 10 percent of the first number. In some implementations of example method 700, the further pretraining is characterized by a second number of tokens that is less than or equal to 5 percent of the first number. In some implementations of example method 700, the further pretraining is characterized by a second number of tokens that is less than or equal to 1 percent of the first number. In some implementations of example method 700, the further pretraining is characterized by a second number of tokens that is less than or equal to 0.5 percent of the first number. In some implementations of example method 700, the further pretraining is characterized by a second number of tokens that is less than or equal to 0.4 percent of the first number. In some implementations of example method 700, the further pretraining is characterized by a second number of tokens that is less than or equal to 0.3 percent of the first number. In some implementations of example method 700, the further pretraining is characterized by a second number of tokens that is less than or equal to 0.2 percent of the first number. In some implementations of example method 700, the further pretraining is characterized by a second number of tokens that is less than or equal to 0.1 percent of the first number. In some implementations of example method 700, the further pretraining is characterized by a second number of tokens that is less than or equal to 0.05 percent of the first number.

In this manner, for instance, the advantages of the presently disclosed techniques can be realized without expending proportional increases in compute to further pretrain an already pretrained model. For instance, the further pretraining can achieve a target performance with a counterfactual savings rate (e.g., as compared to the data/compute cost of continued standard pretraining) of greater than 1.3, such as greater than 1.6, such as greater than 1.9, such as greater than 2, such as greater than 2.3, such as greater than 2.6, such as greater than 2.9.

In some implementations of example method 700, the first set of one or more training examples are characterized by corrupted spans following an initial prefix at a start of an input sequence of a corresponding training example. For example, the first set of one or more training examples can correspond to a PrefixLM-type objective in which bidirectional attention is applied over an initial prefix sequence to autoregressively generate, with causal attention, the corrupted portion.

In some implementations of example method 700, the second set of one or more training examples are characterized by at least one of: corrupted spans having a mean span length between 20 tokens to 40 tokens, or corrupted spans that are corrupted at a rate between 25 percent and 60 percent. For instance, the second set can correspond to a more extreme corruption configuration. Such corrupted spans can have a mean span length between 20 tokens to 40 tokens, which can add a significant level of noise and can challenge the model to infer and reconstruct larger portions of the training example. For example, a span length can be probabilistically sampled from a distribution having a mean between 20 tokens to 40 tokens (e.g., 32 tokens). Alternatively, or in addition, the corrupted spans can be characterized by a corruption rate between 25 percent and 60 percent. This parameter, too, can be probabilistically sampled from a distribution conforming to one or more desired distribution parameters (e.g., mean, etc.). For instance, in a text-based training example, a span of 30 consecutive words may be replaced with one or more placeholder tokens. Up to 60 percent of the words of the text-base training example can be corrupted (e.g., 50%). In some implementations of example method 700, the second set of one or more training examples are characterized by at least one of: corrupted spans having a mean span length of 32 tokens, or corrupted spans that are corrupted at a rate of 50 percent.

In some implementations of example method 700, the plurality of corrupted training examples include twice as many examples in the first set as in the second set. In this manner, for instance, example implementations can prioritize the inductive pathways trained using the first configuration of the objective framework. For instance, if the first set of configuration parameters is designed to simulate mild corruption scenarios, and the second set represents more extreme corruption cases, the model would receive twice as many examples of mild corruption compared to extreme corruption. This ratio can be strategically chosen based on the desired inductive biases and learning outcomes for the model. By adjusting the proportion of examples from each set, the training process can emphasize certain learning behaviors or capabilities.

In some implementations of example method 700, the plurality of corrupted training examples include a third set of one or more training examples that are characterized by corrupted spans having a mean span length less than 10 tokens (e.g., 3 tokens, 4 tokens, 5 tokens, 6 tokens, 7 tokens, 8 tokens, 9 tokens, etc.), wherein subportions of the corrupted spans are corrupted at a rate less than 20 percent (e.g., 5 percent, 10 percent, 15 percent, etc.). For example, the third set can correspond to a milder corruption configuration. In some implementations of example method 700, the plurality of corrupted training examples include a third set of one or more training examples that are characterized by corrupted spans having a mean span length less than 10 tokens, wherein subportions of the corrupted spans are corrupted at a rate less than 20 percent and the plurality of corrupted training examples include twice as many examples in the first set as in the second set; and an equal number of examples in the third set as in the second set. For example, a mixture of all three sets can include 50% first set, 25% second set, and 25% third set.

In some implementations, example method 700 includes training, during the further pre-training, the pretrained machine-learned model to receive a mode-switching token that triggers downstream behavior of the machine-learned model corresponding to a task associated with the mode-switching token. For instance, in some examples, the mode-switching token can be learned in conjunction with use of a particular pretraining objective. For instance, training examples corrupted according to a first configuration of the pretraining objective framework can be appended/prepended/augmented with a token that indicates a first mode. Training examples corrupted according to a second configuration of the pretraining objective framework can be appended/prepended/augmented with a token that indicates a second mode. Training examples corrupted according to a third configuration of the pretraining objective framework can be appended/prepended/augmented with a token that indicates a third mode. In this manner, for instance, the inductive pathways learned using that objective can be activated at inference time by setting the corresponding mode-switching token.

In some implementations of example method 700, the pretrained model was not trained, during the initial pretraining, to receive the mode-switching token that triggers downstream behavior of the machine-learned model corresponding to the task associated with the mode-switching token. For example, the mode-switching behavior can be added in the small amount of further pretraining.

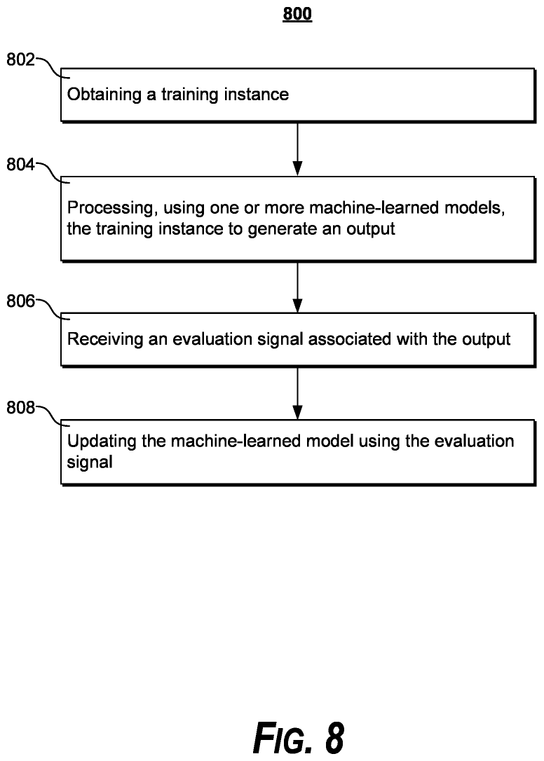

FIG. 8 depicts a flowchart of a method 800 for training one or more machine-learned models according to aspects of the present disclosure. For instance, an example machine-learned model can include a pretrained machine-learned model 200, a model 120, 140, etc.

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

The training instance can be obtained using a further pretraining pipeline 200b.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types. In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

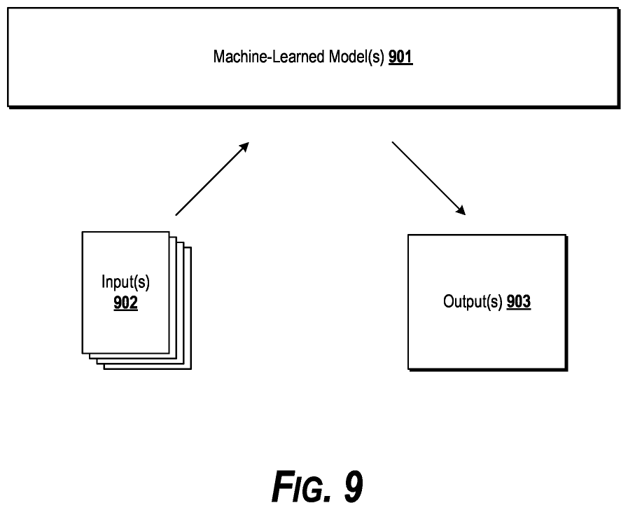

FIG. 9 is a block diagram of an example processing flow for using machine-learned model(s) 901 to process input(s) 902 to generate output(s) 903.

Machine-learned model(s) 901 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 901 can be or include any one of or any part of machine-learned models referenced with respect to the preceding figures (e.g., models 120, 140, 200, etc.). For example, any one or multiple of machine-learned models 120, 140, 200 can be a machine-learned model 901. Features and variations described herein with respect to machine-learned model 901 are to be understood as describing features and variations of any of the machine-learned models described herein. Where this description references machine-learned model 901 it is to be understood that implementations of each of the other models described herein are implicitly referenced and represented thereby.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 901 can include a single or multiple instances of the same model configured to operate on data from input(s) 902. Machine-learned model(s) 901 can include an ensemble of different models that can cooperatively interact to process data from input(s) 902. For example, machine-learned model(s) 901 can employ a mixture-of-experts structure. See, e.g., Zhou et al., Mixture-of-Experts with Expert Choice Routing, ARXIV:2202.09368v2 (Oct. 14, 2022).

Input(s) 902 can generally include or otherwise represent various types of data. Input(s) 902 can include one type or many different types of data. Output(s) 903 can be data of the same type(s) or of different types of data as compared to input(s) 902. Output(s) 903 can include one type or many different types of data.

Example data types for input(s) 902 or output(s) 903 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 902 or outputs 903, example combinations of data types include image data and audio data, image data and natural language data, natural language data and software code data, image data and biometric data, sensor data and medical data, etc. It is to be understood that any combination of data types in an input 902 or an output 903 can be present.

An example input 902 can include one or multiple data types, such as the example data types noted above. An example output 903 can include one or multiple data types, such as the example data types noted above. The data type(s) of input 902 can be the same as or different from the data type(s) of output 903. It is to be understood that the example data types noted above are provided for illustrative purposes only. Data types contemplated within the scope of the present disclosure are not limited to those examples noted above.

### Example Machine-Learned Sequence Processing Models

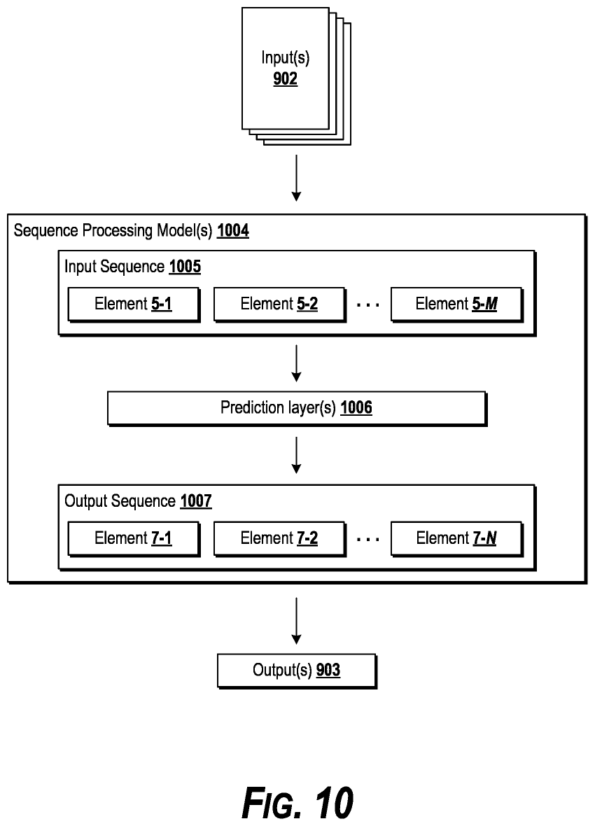

FIG. 10 is a block diagram of an example implementation of an example machine-learned model configured to process sequences of information. For instance, an example implementation of machine-learned model(s) 901 can include machine-learned sequence processing model(s) 1004. An example system can pass input(s) 902 to sequence processing model(s) 1004. Sequence processing model(s) 1004 can include one or more machine-learned components. Sequence processing model(s) 1004 can process the data from input(s) 902 to obtain an input sequence 1005. Input sequence 1005 can include one or more input elements 5-1, 5-2, . . . , 5-M, etc. obtained from input(s) 902. Sequence processing model 1004 can process input sequence 1005 using prediction layer(s) 1006 to generate an output sequence 1007. Output sequence 1007 can include one or more output elements 7-1, 7-2, . . . , 7-N, etc. generated based on input sequence 1005. The system can generate output(s) 903 based on output sequence 1007.

Sequence processing model(s) 1004 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., Musicl. M: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 1004 can process one or multiple types of data simultaneously. Sequence processing model(s) 1004 can include relatively large models (e.g., more parameters, computationally expensive, etc.), relatively small models (e.g., fewer parameters, computationally lightweight, etc.), or both.

In general, sequence processing model(s) 1004 can obtain input sequence 1005 using data from input(s) 902. For instance, input sequence 1005 can include a representation of data from input(s) 902 in a format understood by sequence processing model(s) 1004. One or more machine-learned components of sequence processing model(s) 1004 can ingest the data from input(s) 902, parse the data into pieces compatible with the processing architectures of sequence processing model(s) 1004 (e.g., via “tokenization”), and project the pieces into an input space associated with prediction layer(s) 1006 (e.g., via “embedding”).

Sequence processing model(s) 1004 can ingest the data from input(s) 902 and parse the data into a sequence of elements to obtain input sequence 1005. For example, a portion of input data from input(s) 902 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 1005. It is to be understood that element(s) 5-1, 5-2, . . . , 5-M depicted in FIG. 10 can be the tokens or can be the embedded representations thereof.

Prediction layer(s) 1006 can predict one or more output elements 7-1, 7-2, . . . , 7-N based on the input elements. Prediction layer(s) 1006 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 1006 can predict new output element(s) in view of the context provided by input sequence 1005.

Prediction layer(s) 1006 can evaluate associations between portions of input sequence 1005 and a particular output element. These associations can inform a prediction of the likelihood that a particular output follows the input context. For example, consider the textual snippet, “The carpenter's toolbox was small and heavy. It was full of ______.” Example prediction layer(s) 1006 can identify that “It” refers back to “toolbox” by determining a relationship between the respective embeddings. Example prediction layer(s) 1006 can also link “It” to the attributes of the toolbox, such as “small” and “heavy.” Based on these associations, prediction layer(s) 1006 can, for instance, assign a higher probability to the word “nails” than to the word “sawdust.”

A transformer is an example architecture that can be used in prediction layer(s) 1006. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 1005 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 1006 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 1006 can leverage various kinds of artificial neural networks that can understand or generate sequences of information.

Output sequence 1007 can include or otherwise represent the same or different data types as input sequence 1005. For instance, input sequence 1005 can represent textual data, and output sequence 1007 can represent textual data. Input sequence 1005 can represent image, audio, or audiovisual data, and output sequence 1007 can represent textual data (e.g., describing the image, audio, or audiovisual data). It is to be understood that prediction layer(s) 1006, and any other interstitial model components of sequence processing model(s) 1004, can be configured to receive a variety of data types in input sequence(s) 1005 and output a variety of data types in output sequence(s) 1007.

Output sequence 1007 can have various relationships to input sequence 1005. Output sequence 1007 can be a continuation of input sequence 1005. Output sequence 1007 can be complementary to input sequence 1005. Output sequence 1007 can translate, transform, augment, or otherwise modify input sequence 1005. Output sequence 1007 can answer, evaluate, confirm, or otherwise respond to input sequence 1005. Output sequence 1007 can implement (or describe instructions for implementing) an instruction provided via input sequence 1005.

Output sequence 1007 can be generated autoregressively. For instance, for some applications, an output of one or more prediction layer(s) 1006 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 1007 can be autoregressively generated by sampling a likely next output element, adding that element to the context window, and re-generating the probability distribution based on the updated context window, and sampling a likely next output element, and so forth.

Output sequence 1007 can also be generated non-autoregressively. For instance, multiple output elements of output sequence 1007 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 1007 can include one or multiple portions or elements. In an example content generation configuration, output sequence 1007 can include multiple elements corresponding to multiple portions of a generated output sequence (e.g., a textual sentence, values of a discretized waveform, computer code, etc.). In an example classification configuration, output sequence 1007 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

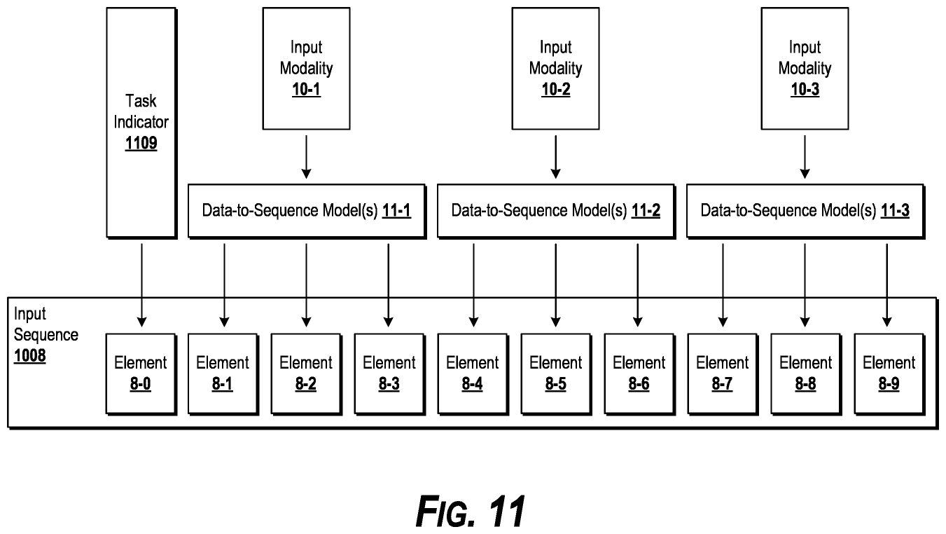

FIG. 11 is a block diagram of an example technique for populating an example input sequence 1008. Input sequence 1008 can include various functional elements that form part of the model infrastructure, such as an element 8-0 obtained from a task indicator 1109 that signals to any model(s) that process input sequence 1008 that a particular task is being performed (e.g., to help adapt a performance of the model(s) to that particular task). Input sequence 1008 can include various data elements from different data modalities. For instance, an input modality 10-1 can include one modality of data. A data-to-sequence model 11-1 can process data from input modality 10-1 to project the data into a format compatible with input sequence 1008 (e.g., one or more vectors dimensioned according to the dimensions of input sequence 1008) to obtain elements 8-1, 8-2, 8-3. Another input modality 10-2 can include a different modality of data. A data-to-sequence model 11-2 can project data from input modality 10-2 into a format compatible with input sequence 1008 to obtain elements 8-4, 8-5, 8-6. Another input modality 10-3 can include yet another different modality of data. A data-to-sequence model 11-3 can project data from input modality 10-3 into a format compatible with input sequence 1008 to obtain elements 8-7, 8-8, 8-9.

Input sequence 1008 can be the same as or different from input sequence 1005. Input sequence 1008 can be a multimodal input sequence that contains elements that represent data from different modalities using a common dimensional representation. For instance, an embedding space can have P dimensions. Input sequence 1008 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 1109 can include a model or model component configured to identify a task being performed and inject, into input sequence 1008, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 902 and output(s) 903).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 1008 (e.g., elements 8-1, 8-2, 8-3, etc.). An image data-to-sequence model can subdivide an input image and project the subdivisions into element(s) in input sequence 1008 (e.g., elements 8-4, 8-5, 8-6, etc.). An arbitrary datatype data-to-sequence model can subdivide an input of that arbitrary datatype and project the subdivisions into element(s) in input sequence 1008 (e.g., elements 8-7, 8-8, 8-9, etc.).

Data-to-sequence models 11-1, 11-2, and 11-3 can form part of machine-learned sequence processing model(s) 1004. Data-to-sequence models 11-1, 11-2, and 11-3 can be jointly trained with or trained independently from machine-learned sequence processing model(s) 1004. Data-to-sequence models 11-1, 11-2, and 11-3 can be trained end-to-end with machine-learned sequence processing model(s) 1004.

### Example Machine-Learned Model Development Platform

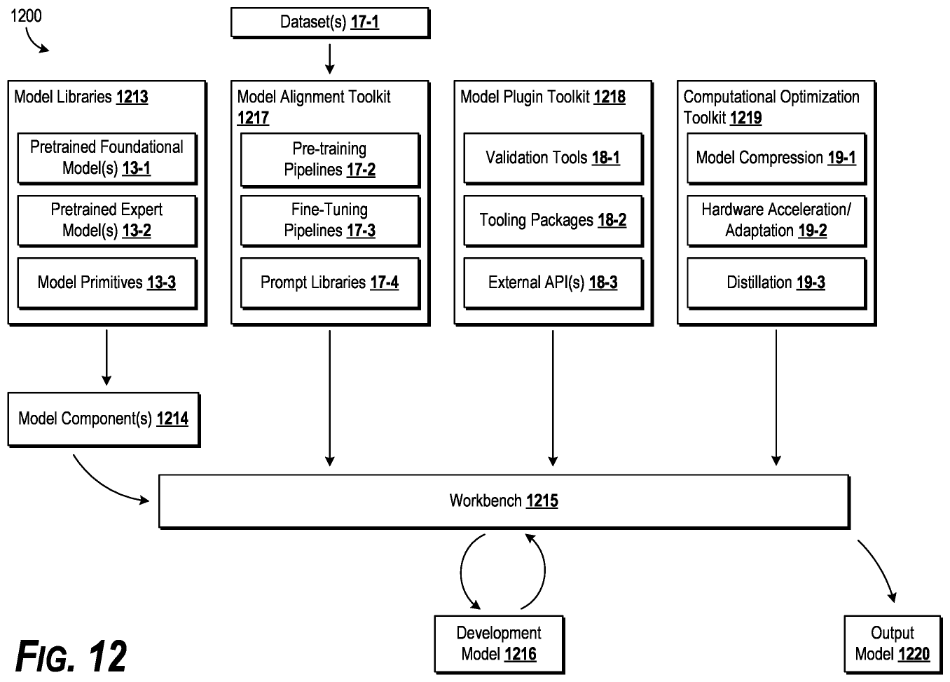

FIG. 12 is a block diagram of an example model development platform 1200 that can facilitate creation, adaptation, and refinement of example machine-learned models (e.g., machine-learned model(s) 901, sequence processing model(s) 1004, etc.). Model development platform 1200 can provide a number of different toolkits that developer systems can employ in the development of new or adapted machine-learned models.

Model development platform 1200 can provide one or more model libraries 1213 containing building blocks for new models. Model libraries 1213 can include one or more pre-trained foundational models 13-1, which can provide a backbone of processing power across various tasks. Model libraries 1213 can include one or more pre-trained expert models 13-2, which can be focused on performance in particular domains of expertise. Model libraries 1213 can include various model primitives 13-3, which can provide low-level architectures or components (optionally pre-trained), which can be assembled in various arrangements as desired.

Model development platform 1200 can receive selections of various model components 1214. Model development platform 1200 can pass selected model components 1214 to a workbench 1215 that combines selected model components 1214 into a development model 1216.

Workbench 1215 can facilitate further refinement and adaptation of development model 1216 by leveraging a number of different toolkits integrated with model development platform 1200. For example, workbench 1215 can facilitate alignment of the development model 1216 with a desired performance profile on various tasks using a model alignment toolkit 1217.

Model alignment toolkit 1217 can provide a number of tools for causing development model 1216 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 1217 can integrate one or more dataset(s) 17-1 for aligning development model 1216. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 1216 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 1215 can implement a pre-training pipeline 17-2 to pre-train development model 1216.

Pre-training pipelines 17-2 can implement example techniques for pretraining using diverse pretraining objectives as described herein.

Fine-tuning pipelines 17-3 can include a machine-learned model training workflow configured to refine the model parameters of development model 1216 with higher-quality data. Fine-tuning pipelines 17-3 can update development model 1216 by conducting supervised training with labeled dataset(s) in dataset(s) 17-1. Fine-tuning pipelines 17-3 can update development model 1216 by conducting reinforcement learning using reward signals from user feedback signals. Workbench 1215 can implement a fine-tuning pipeline 17-3 to fine-tune development model 1216.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 1215.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 1215 can implement prompt engineering tools in development model 1216.

Prompt libraries 17-4 can include pipelines for prompt generation. For example, inputs can be generated using development model 1216 itself or other machine-learned models. In this manner, for instance, a first model can process information about a task and output a input for a second model to process in order to perform a step of the task. The second model can be the same as or different from the first model. Workbench 1215 can implement prompt generation pipelines in development model 1216.

Prompt libraries 17-4 can include pipelines for context injection. For instance, a performance of development model 1216 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 1215 can implement context injection pipelines in development model 1216.

Although various training examples described herein with respect to model development platform 1200 refer to “pre-training” and “fine-tuning,” it is to be understood that model alignment toolkit 1217 can generally support a wide variety of training techniques adapted for training a wide variety of machine-learned models. Example training techniques can correspond to the example training method 800 described above.

Model development platform 1200 can include a model plugin toolkit 1218. Model plugin toolkit 1218 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 1218 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 1218 can include tooling packages 18-2 for implementing one or more tools that can include scripts or other executable code that can be executed alongside development model 1216. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 1218 can include interfaces for calling external application programming interfaces (APIs) 18-3. For instance, in addition to or in lieu of implementing tool calls or tool code directly with development model 1216, development model 1216 can be aligned to output instruction that initiate API calls to send or obtain data via external systems.

Model plugin toolkit 1218 can integrate with prompt libraries 17-4 to build a catalog of available tools for use with development model 1216. For instance, a model can receive, in an input, a catalog of available tools, and the model can generate an output that selects a tool from the available tools and initiates a tool call for using the tool.

Model development platform 1200 can include a computational optimization toolkit 1219 for optimizing a computational performance of development model 1216. For instance, tools for model compression 19-1 can allow development model 1216 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 1216. For instance, development model 1216 can be a highly performant, large machine-learned model optimized using model development platform 1200. To obtain a lightweight model for running in resource-constrained environments, a smaller model can be a “student model” that learns to imitate development model 1216 as a “teacher model.” In this manner, for instance, the investment in learning the parameters and configurations of development model 1216 can be efficiently transferred to a smaller model for more efficient inference.

Workbench 1215 can implement one, multiple, or none of the toolkits implemented in model development platform 1200. Workbench 1215 can output an output model 1220 based on development model 1216. Output model 1220 can be a deployment version of development model 1216. Output model 1220 can be a development or training checkpoint of development model 1216. Output model 1220 can be a distilled, compressed, or otherwise optimized version of development model 1216.

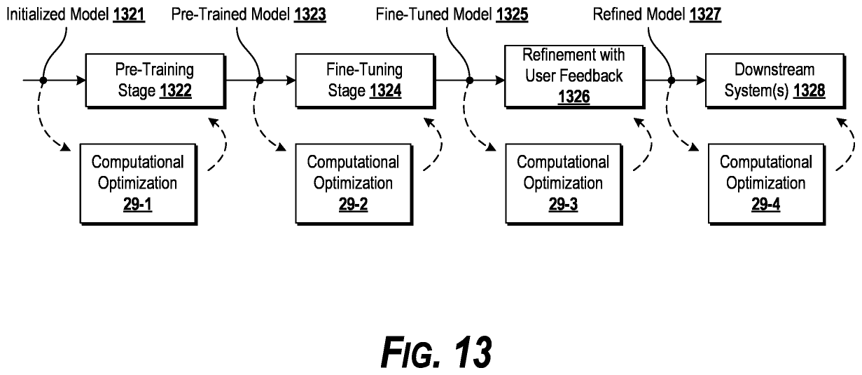

FIG. 13 is a block diagram of an example training flow for training a machine-learned development model 1216. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 1216 can persist in an initial state as an initialized model 1321. Development model 1216 can be initialized with weight values. Initial weight values can be random or based on an initialization schema. Initial weight values can be based on prior pre-training for the same or for a different model.

Initialized model 1321 can undergo pre-training in one or more pre-training stage(s) 1322. One or more pre-training stage(s) 1322 can be implemented using one or more pre-training pipelines 17-2 over data from dataset(s) 17-1. Pre-training can be omitted, for example, if initialized model 1321 is already pre-trained (e.g., development model 1216 contains, is, or is based on a pre-trained foundational model or an expert model).

Pre-trained model 1323 can then be a new version of development model 1216, which can persist as development model 1216 or as a new development model. Pre-trained model 1323 can be the initial state if development model 1216 was already pre-trained. Pre-trained model 1323 can undergo fine-tuning in a fine-tuning stage 1324. Fine-tuning stage 1324 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 1329 can then be a new version of development model 1216, which can persist as development model 1216 or as a new development model. Fine-tuned model 1329 can be the initial state if development model 1216 was already fine-tuned. Fine-tuned model 1329 can undergo refinement with user feedback 1326. For instance, refinement with user feedback 1326 can include reinforcement learning, optionally based on human feedback from human users of fine-tuned model 1325. As reinforcement learning can be a form of fine-tuning, it is to be understood that fine-tuning stage 1324 can subsume the stage for refining with user feedback 1326. Refinement with user feedback 1326 can produce a refined model 1327. Refined model 1327 can be output to downstream system(s) 1328 for deployment or further development.

In some implementations, computational optimization operations can be applied before, during, or after each stage. For instance, initialized model 1321 can undergo computational optimization 29-1 (e.g., using computational optimization toolkit 1219) before one or more pre-training stage(s) 1322. Pre-trained model 1323 can undergo computational optimization 29-2 (e.g., using computational optimization toolkit 1219) before fine-tuning stage 1324. Fine-tuned model 1425 can undergo computational optimization 29-3 (e.g., using computational optimization toolkit 1219) before refinement with user feedback 1326. Refined model 1327 can undergo computational optimization 29-4 (e.g., using computational optimization toolkit 1219) before output to downstream system(s) 1328. Computational optimization(s) 29-1, . . . , 29-4 can all be the same, all be different, or include at least some different optimization techniques.

### Example Machine-Learned Model Inference System

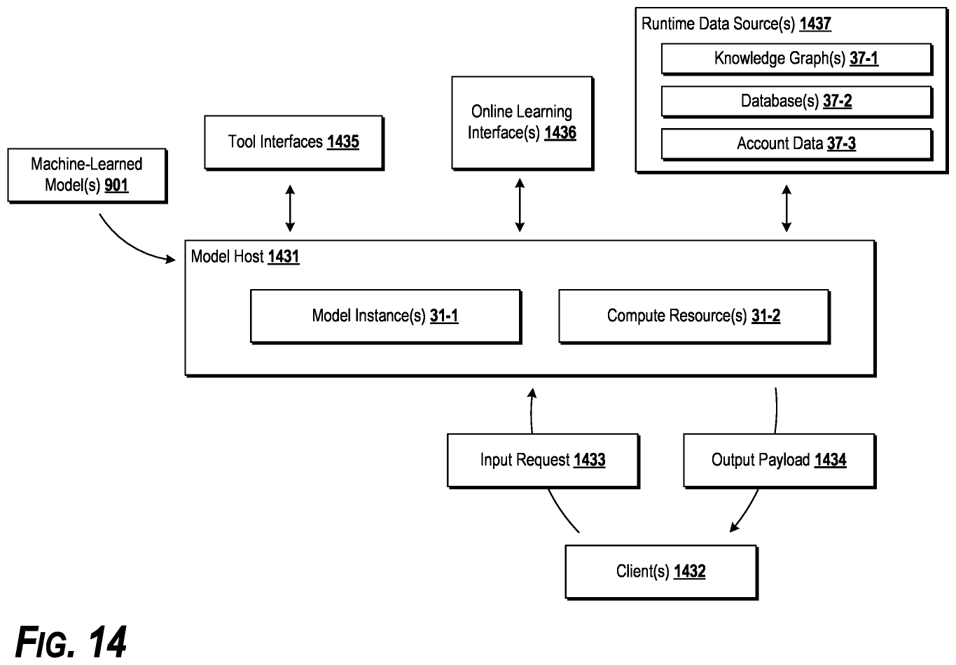

FIG. 14 is a block diagram of an inference system for operating one or more machine-learned model(s) 901 to perform inference (e.g., for training, for deployment, etc.). A model host 1431 can receive machine-learned model(s) 901. Model host 1431 can host one or more model instance(s) 31-1, which can be one or multiple instances of one or multiple models. Model host 1431 can host model instance(s) 31-1 using available compute resources 31-2 associated with model host 1431.

Model host 1431 can perform inference on behalf of one or more client(s) 1432. Client(s) 1432 can transmit an input request(s) 1433 to model host 1431. Using input request(s) 1433, model host 1431 can obtain input(s) 902 for input to machine-learned model(s) 901. Machine-learned model(s) 901 can process input(s) 902 to generate output(s) 903. Using output(s) 903, model host 1431 can return an output payload(s) 1434 for responding to input request(s) 1433 from client(s) 1432. Output payload(s) 1434 can include or be based on output(s) 903.

Model host 1431 can leverage various other resources and tools to augment the inference task. For instance, model host 1431 can communicate with tool interfaces 1435 to facilitate tool use by model instance(s) 31-1. Tool interfaces 1435 can include local or remote APIs. Tool interfaces 1435 can include integrated scripts or other software functionality. Model host 1431 can engage online learning interface(s) 1436 to facilitate ongoing improvements to machine-learned model(s) 901. For instance, online learning interface(s) 1436 can be used within reinforcement learning loops to retrieve user feedback on inferences served by model host 1431. Model host 1431 can access runtime data source(s) 1437 for augmenting input(s) 902 with additional contextual information. For instance, runtime data source(s) 1437 can include a knowledge graph 37-1 that facilitates structured information retrieval for information associated with input request(s) 1433 (e.g., a search engine service). Runtime data source(s) 1437 can include public or private, external or local database(s) 37-2 that can store information associated with input request(s) 1433 for augmenting input(s) 902. Runtime data source(s) 1437 can include account data 37-3 which can be retrieved in association with a user account corresponding to one or more client(s) 1432 for customizing the behavior of model host 1431 accordingly.

Model host 1431 can be implemented by one or multiple computing devices or systems. Client(s) 1432 can be implemented by one or multiple computing devices or systems, which can include computing devices or systems shared with model host 1431.

For example, model host 1431 can operate on a server system that provides a machine-learning service to client device(s) that operate client(s) 1432 (e.g., over a local or wide-area network). Client device(s) can be end-user devices used by individuals. Client device(s) can be server systems that operate client(s) 1432 to provide various functionality as a service to downstream end-user devices.

In some implementations, model host 1431 can operate on a same device or system as client(s) 1432. Model host 1431 can be a machine-learning service that runs on-device to provide machine-learning functionality to one or multiple applications operating on a client device, which can include an application implementing client(s) 1432. Model host 1431 can be a part of a same application as client(s) 1432. For instance, model host 1431 can be a subroutine or method implemented by one part of an application, and client(s) 1432 can be another subroutine or method that engages model host 1431 to perform inference functions within the application. It is to be understood that model host 1431 and client(s) 1432 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request(s) 1433 can include data for input(s) 902. Model host 1431 can process input request(s) 1433 to obtain input(s) 902. Input(s) 902 can be obtained directly from input request(s) 1433 or can be retrieved using input request(s) 1433. Input request(s) 1433 can be submitted to model host 1431 via an API.

Model host 1431 can perform inference over batches of input requests 33 in parallel. For instance, a model instance 31-1 can be configured with an input structure that has a batch dimension. Separate input(s) 902 can be distributed across the batch dimension (e.g., rows of an array). The separate input(s) 902 can include completely different contexts. The separate input(s) 902 can be multiple inference steps of the same task. The separate input(s) 902 can be staggered in an input structure, such that any given inference cycle can be operating on different portions of the respective input(s) 902. In this manner, for instance, model host 1431 can perform inference on the batch in parallel, such that output(s) 903 can also contain the batch dimension and return the inference results for the batched input(s) 902 in parallel. In this manner, for instance, batches of input request(s) 1433 can be processed in parallel for higher throughput of output payload(s) 1434.

Output payload(s) 1434 can include or be based on output(s) 903 from machine-learned model(s) 901. Model host 1431 can process output(s) 903 to obtain output payload(s) 1434. This can include chaining multiple rounds of inference (e.g., iteratively, recursively, across the same model(s) or different model(s)) to arrive at a final output for a task to be returned in output payload(s) 1434. Output payload(s) 1434 can be transmitted to client(s) 1432 via an API.

Online learning interface(s) 1436 can facilitate reinforcement learning of machine-learned model(s) 901. Online learning interface(s) 1436 can facilitate reinforcement learning with human feedback (RLHF). Online learning interface(s) 1436 can facilitate federated learning of machine-learned model(s) 901.

Model host 1431 can execute machine-learned model(s) 901 to perform inference for various tasks using various types of data. For example, various different input(s) 902 and output(s) 903 can be used for various different tasks. In some implementations, input(s) 902 can be or otherwise represent image data. Machine-learned model(s) 901 can process the image data to generate an output. As an example, machine-learned model(s) 901 can process the image data to generate an image recognition output (e.g., a recognition of the image data, a latent embedding of the image data, an encoded representation of the image data, a hash of the image data, etc.). As another example, machine-learned model(s) 901 can process the image data to generate an image segmentation output. As another example, machine-learned model(s) 901 can process the image data to generate an image classification output. As another example, machine-learned model(s) 901 can process the image data to generate an image data modification output (e.g., an alteration of the image data, etc.). As another example, machine-learned model(s) 901 can process the image data to generate an encoded image data output (e.g., an encoded and/or compressed representation of the image data, etc.). As another example, machine-learned model(s) 901 can process the image data to generate an upscaled image data output. As another example, machine-learned model(s) 901 can process the image data to generate a prediction output.

In some implementations, the task is a computer vision task. In some cases, input(s) 902 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 902 can be or otherwise represent natural language data. Machine-learned model(s) 901 can process the natural language data to generate an output. As an example, machine-learned model(s) 901 can process the natural language data to generate a language encoding output. As another example, machine-learned model(s) 901 can process the natural language data to generate a latent text embedding output. As another example, machine-learned model(s) 901 can process the natural language data to generate a translation output. As another example, machine-learned model(s) 901 can process the natural language data to generate a classification output. As another example, machine-learned model(s) 901 can process the natural language data to generate a textual segmentation output. As another example, machine-learned model(s) 901 can process the natural language data to generate a semantic intent output. As another example, machine-learned model(s) 901 can process the natural language data to generate an upscaled text or natural language output (e.g., text or natural language data that is higher quality than the input text or natural language, etc.). As another example, machine-learned model(s) 901 can process the natural language data to generate a prediction output (e.g., one or more predicted next portions of natural language content).

In some implementations, input(s) 902 can be or otherwise represent speech data (e.g., data describing spoken natural language, such as audio data, textual data, etc.). Machine-learned model(s) 901 can process the speech data to generate an output. As an example, machine-learned model(s) 901 can process the speech data to generate a speech recognition output. As another example, machine-learned model(s) 901 can process the speech data to generate a speech translation output. As another example, machine-learned model(s) 901 can process the speech data to generate a latent embedding output. As another example, machine-learned model(s) 901 can process the speech data to generate an encoded speech output (e.g., an encoded and/or compressed representation of the speech data, etc.). As another example, machine-learned model(s) 901 can process the speech data to generate an upscaled speech output (e.g., speech data that is higher quality than the input speech data, etc.). As another example, machine-learned model(s) 901 can process the speech data to generate a textual representation output (e.g., a textual representation of the input speech data, etc.). As another example, machine-learned model(s) 901 can process the speech data to generate a prediction output.

In some implementations, input(s) 902 can be or otherwise represent latent encoding data (e.g., a latent space representation of an input, etc.). Machine-learned model(s) 901 can process the latent encoding data to generate an output. As an example, machine-learned model(s) 901 can process the latent encoding data to generate a recognition output. As another example, machine-learned model(s) 901 can process the latent encoding data to generate a reconstruction output. As another example, machine-learned model(s) 901 can process the latent encoding data to generate a search output. As another example, machine-learned model(s) 901 can process the latent encoding data to generate a reclustering output. As another example, machine-learned model(s) 901 can process the latent encoding data to generate a prediction output.

In some implementations, input(s) 902 can be or otherwise represent statistical data. Statistical data can be, represent, or otherwise include data computed and/or calculated from some other data source. Machine-learned model(s) 901 can process the statistical data to generate an output. As an example, machine-learned model(s) 901 can process the statistical data to generate a recognition output. As another example, machine-learned model(s) 901 can process the statistical data to generate a prediction output. As another example, machine-learned model(s) 901 can process the statistical data to generate a classification output. As another example, machine-learned model(s) 901 can process the statistical data to generate a segmentation output. As another example, machine-learned model(s) 901 can process the statistical data to generate a visualization output. As another example, machine-learned model(s) 901 can process the statistical data to generate a diagnostic output.

In some implementations, input(s) 902 can be or otherwise represent sensor data. Machine-learned model(s) 901 can process the sensor data to generate an output. As an example, machine-learned model(s) 901 can process the sensor data to generate a recognition output. As another example, machine-learned model(s) 901 can process the sensor data to generate a prediction output. As another example, machine-learned model(s) 901 can process the sensor data to generate a classification output. As another example, machine-learned model(s) 901 can process the sensor data to generate a segmentation output. As another example, machine-learned model(s) 901 can process the sensor data to generate a visualization output. As another example, machine-learned model(s) 901 can process the sensor data to generate a diagnostic output. As another example, machine-learned model(s) 901 can process the sensor data to generate a detection output.

In some implementations, machine-learned model(s) 901 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 901 can be configured to output content generated in view of input(s) 902. For instance, input(s) 902 can be or otherwise represent data of one or more modalities that encodes context for generating additional content.

In some implementations, the task can be a text completion task. Machine-learned model(s) 901 can be configured to process input(s) 902 that represent textual data and to generate output(s) 903 that represent additional textual data that completes a textual sequence that includes input(s) 902. For instance, machine-learned model(s) 901 can be configured to generate output(s) 903 to complete a sentence, paragraph, or portion of text that follows from a portion of text represented by input(s) 902.

In some implementations, the task can be an instruction following task. Machine-learned model(s) 901 can be configured to process input(s) 902 that represent instructions to perform a function and to generate output(s) 903 that advance a goal of satisfying the instruction function (e.g., at least a step of a multi-step procedure to perform the function). Output(s) 903 can represent data of the same or of a different modality as input(s) 902. For instance, input(s) 902 can represent textual data (e.g., natural language instructions for a task to be performed) and machine-learned model(s) 901 can process input(s) 902 to generate output(s) 903 that represent textual data responsive to the instructions (e.g., natural language responses, programming language responses, machine language responses, etc.). Input(s) 902 can represent image data (e.g., image-based instructions for a task to be performed, optionally accompanied by textual instructions) and machine-learned model(s) 901 can process input(s) 902 to generate output(s) 903 that represent textual data responsive to the instructions (e.g., natural language responses, programming language responses, machine language responses, etc.). One or more output(s) 903 can be iteratively or recursively generated to sequentially process and accomplish steps toward accomplishing the requested functionality. For instance, an initial output can be executed by an external system or be processed by machine-learned model(s) 901 to complete an initial step of performing a function. Multiple steps can be performed, with a final output being obtained that is responsive to the initial instructions.

In some implementations, the task can be a question answering task. Machine-learned model(s) 901 can be configured to process input(s) 902 that represent a question to answer and to generate output(s) 903 that advance a goal of returning an answer to the question (e.g., at least a step of a multi-step procedure to perform the function). Output(s) 903 can represent data of the same or of a different modality as input(s) 902. For instance, input(s) 902 can represent textual data (e.g., natural language instructions for a task to be performed) and machine-learned model(s) 901 can process input(s) 902 to generate output(s) 903 that represent textual data responsive to the question (e.g., natural language responses, programming language responses, machine language responses, etc.). Input(s) 902 can represent image data (e.g., image-based instructions for a task to be performed, optionally accompanied by textual instructions) and machine-learned model(s) 901 can process input(s) 902 to generate output(s) 903 that represent textual data responsive to the question (e.g., natural language responses, programming language responses, machine language responses, etc.). One or more output(s) 903 can be iteratively or recursively generated to sequentially process and accomplish steps toward answering the question. For instance, an initial output can be executed by an external system or be processed by machine-learned model(s) 901 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 901 can be configured to process input(s) 902 that represent context regarding a desired portion of image content. The context can include text data, image data, audio data, etc. Machine-learned model(s) 901 can be configured to generate output(s) 903 that represent image data that depicts imagery related to the context. For instance, machine-learned model(s) 901 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 901 can be configured to process input(s) 902 that represent context regarding a desired portion of audio content. The context can include text data, image data, audio data, etc. Machine-learned model(s) 901 can be configured to generate output(s) 903 that represent audio data related to the context. For instance, machine-learned model(s) 901 can be configured to generate waveform data in the form of an image (e.g., a spectrogram). Values for channel(s) associated with pixels of the image can be selected based on the context. Machine-learned model(s) 901 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 901 can be configured to process input(s) 902 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 901 can be configured to generate output(s) 903 that represent data that aligns with the desired data. For instance, machine-learned model(s) 901 can be configured to generate data values for populating a dataset. Values for the data object(s) can be selected based on the context (e.g., based on a probability determined based on the context).

### Example Computing Systems and Devices

FIG. 1A is a block diagram of an example networked computing system that can perform aspects of example implementations of the present disclosure. The system can include a number of computing devices and systems that are communicatively coupled over a network 180. An example computing device 102 is described to provide an example of a computing device that can perform any aspect of the present disclosure (e.g., implementing model host 1431, client(s) 1432, or both). An example server computing system 130 is described as an example of a server computing system that can perform any aspect of the present disclosure (e.g., implementing model host 1431, client(s) 1432, or both). Computing device 102 and server computing system(s) 130 can cooperatively interact (e.g., over network 49) to perform any aspect of the present disclosure (e.g., implementing model host 1431, client(s) 1432, or both).

Other computing systems can participate in the networked environment. A model development platform system is an example system that can host or serve model development platform(s) 1200 for development of machine-learned models. Third-party system(s) are example system(s) with which any of computing device 102, server computing system(s) 130, or a model development platform system(s) can interact in the performance of various aspects of the present disclosure (e.g., engaging third-party tools, accessing third-party databases or other resources, etc.).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method of improving performance of a pretrained a machine-learned model by further pretraining with diverse objectives, comprising:
obtaining, by a computing system comprising one or more processors, a pretrained machine-learned model that was initially pretrained using a pretraining dataset;
further pretraining the pretrained machine-learned model by:
generating, by the computing system and using a pretraining objective framework, a plurality of corrupted training examples from one or more training examples obtained from the pretraining dataset,
wherein the plurality of corrupted training examples comprise:
a first set of one or more training examples corrupted according to a first set of configuration parameters of the pretraining objective framework; and
a second set of one or more training examples corrupted according to a second set of configuration parameters of the pretraining objective framework;
inputting, by the computing system, the plurality of corrupted training examples into the pretrained machine-learned model, wherein the pretrained machine-learned model is configured to generate uncorrupted subportions corresponding to corrupted subportions of the plurality of corrupted training examples;
obtaining, by the computing system and from the pretrained machine-learned model, a plurality of outputs respectively generated by the pretrained machine-learned model based on the plurality of corrupted training examples; and
updating, by the computing system, one or more parameters of the pretrained machine-learned model based on an evaluation of the plurality of outputs.

2. The method of claim 1, wherein the one or more training examples were already used during the pretraining of the pretrained machine-learned model.

3. The method of claim 1, wherein:
the pretrained machine-learned model was initially pretrained using a first number of floating point operations (FLOPs); and
the further pretraining is characterized by a second number of FLOPs that is less than or equal to one percent of the first number.

4. The method of claim 1, wherein:
the pretrained machine-learned model was initially pretrained using a first number of floating point operations (FLOPs); and
the further pretraining is characterized by a second number of FLOPs that is less than or equal to one tenth of one percent of the first number.

5. The method of claim 1, wherein:
the pretrained machine-learned model was initially pretrained using a first number of tokens from the pretraining dataset; and
the further pretraining is characterized by a second number of tokens that is less than or equal to one percent of the first number.

6. The method of claim 1, wherein:
the pretrained machine-learned model was initially pretrained using a first number of tokens from the pretraining dataset; and
the further pretraining is characterized by a second number of tokens that is less than or equal to one tenth of one percent of the first number.

7. The method of claim 1, wherein the initial pretraining was based on a causal language modeling objective.

8. The method of claim 1, wherein the initial pretraining was based on one of more objectives consisting essentially of a causal language modeling objective.

9. The method of claim 1, wherein:
the first set of one or more training examples are characterized by corrupted spans following an initial prefix at a start of an input sequence of a corresponding training example;
the second set of one or more training examples are characterized by at least one of:
corrupted spans having a mean span length between 20 tokens to 40 tokens, or
corrupted spans that are corrupted at a rate between 25 percent and 60 percent.

10. The method of claim 9, wherein the second set of one or more training examples are characterized by at least one of:
corrupted spans having a mean span length of 32 tokens, or
corrupted spans that are corrupted at a rate of 50 percent.

11. The method of claim 9, wherein the plurality of corrupted training examples comprise at least twice as many examples in the first set as in the second set.

12. The method of claim 10, wherein the plurality of corrupted training examples comprise:
a third set of one or more training examples that are characterized by corrupted spans having a mean span length less than 10 tokens, wherein subportions of the corrupted spans are corrupted at a rate less than 20 percent.

13. The method of claim 11, wherein:
the plurality of corrupted training examples comprise a third set of one or more training examples that are characterized by corrupted spans having a mean span length less than 10 tokens, wherein subportions of the corrupted spans are corrupted at a rate less than 20 percent; and
the plurality of corrupted training examples comprise:
at least twice as many examples in the first set as in the second set; and
an equal number of examples in the third set as in the second set.

14. The method of claim 1, comprising:
training, during the further pre-training, the pretrained machine-learned model to receive a mode-switching token that triggers downstream behavior of the machine-learned model corresponding to a task associated with the mode-switching token.

15. The method of claim 14, wherein the pretrained model was not trained, during the initial pretraining, to receive the mode-switching token that triggers downstream behavior of the machine-learned model corresponding to the task associated with the mode-switching token.

16. One or more non-transitory, computer-readable media storing:
a pretrained machine-learned model having parameters that were obtained using at least two stages of pretraining, a first stage of pretraining using a pretraining dataset, and a second stage of the pretraining comprising:
further pretraining the pretrained machine-learned model by:
generating using a pretraining objective framework, a plurality of corrupted training examples from one or more training examples obtained from the pretraining dataset,
wherein the plurality of corrupted training examples comprise:
a first set of one or more training examples corrupted according to a first set of configuration parameters of the pretraining objective framework; and
a second set of one or more training examples corrupted according to a second set of configuration parameters of the pretraining objective framework;
inputting the plurality of corrupted training examples into the pretrained machine-learned model, wherein the pretrained machine-learned model is configured to generate uncorrupted subportions corresponding to corrupted subportions of the plurality of corrupted training examples;
obtaining, from the pretrained machine-learned model, a plurality of outputs respectively generated by the pretrained machine-learned model based on the plurality of corrupted training examples; and
updating one or more parameters of the pretrained machine-learned model based on an evaluation of the plurality of outputs.

17. The one or more non-transitory, computer-readable media of claim 16, wherein the pretrained machine-learned model comprises a decoder-only model.

18. The one or more non-transitory, computer-readable media of claim 16, wherein the pretrained machine-learned model comprises an encoder-decoder model.

19. The one or more non-transitory, computer-readable media of claim 16, wherein the one or more training examples were already used during the pretraining of the pretrained machine-learned model.

20. A computing system, comprising:
one or more processors; and
one or more non-transitory, computer-readable media storing:
a pretrained machine-learned model having parameters that were obtained using at least two stages of pretraining, a first stage of pretraining using a pretraining dataset, and a second stage of the pretraining comprising:
further pretraining the pretrained machine-learned model by:
generating, using a pretraining objective framework, a plurality of corrupted training examples from one or more training examples obtained from the pretraining dataset,
wherein the plurality of corrupted training examples comprise:
a first set of one or more training examples corrupted according to a first set of configuration parameters of the pretraining objective framework; and
a second set of one or more training examples corrupted according to a second set of configuration parameters of the pretraining objective framework;
inputting the plurality of corrupted training examples into the pretrained machine-learned model, wherein the pretrained machine-learned model is configured to generate uncorrupted subportions corresponding to corrupted subportions of the plurality of corrupted training examples;
obtaining, from the pretrained machine-learned model, a plurality of outputs respectively generated by the pretrained machine-learned model based on the plurality of corrupted training examples; and
updating one or more parameters of the pretrained machine-learned model based on an evaluation of the plurality of outputs;
instructions that are executable to cause the one or more processors to perform operations, the operations comprising:
receiving one or more inputs for processing using the pretrained machine-learned model; and
generating, by processing the one or more inputs using the pretrained machine-learned model, one or more outputs.
